(19) United States
(12) Patent Application Publication
(10) Pub. No.: US 2007/0058146 A1
(43) Pub. Date: Mar. 15, 2007

(54) Exposure apparatus, exposure method, position control method, and method for producing device

(75) Inventor: Atsushi Yamaguchi, Chigasaki (JP)

Correspondence Address: OLIFF & BERRIDGE, PLC, P.O. BOX 19928, ALEXANDRIA, VA, 22320, US

(73) Assignee: Nikon Corporation, CHIYODA-KU, TOKYO (JP)

(21) Appl. No.: 10/588,163

(22) PCT Filed: Feb. 3, 2005
(86) PCT No.: PCT/JP05/01993

§ 371 Date: Aug. 1, 2006

(30) Foreign Application Priority Data
Feb. 4, 2004 (JP) 2004-028091

(51) Int. Cl. G03B 27/42

(52) U.S. Cl. 355/53

(57) ABSTRACT

Exposure apparatus EX exposes a substrate P through a liquid LQ. The exposure apparatus is provided with a substrate stage PST which can hold the substrate P, an interferometer system (43), which projects a measuring light on a reflecting plane formed on a moving mirror on the substrate stage PST, receives the reflected light and measures position information of the substrate stage PST, and a memory MRY, which stores error.

### TECHNICAL FIELD

The present invention relates to an exposure apparatus, an exposure method, a position control method, and a method for producing a device, in which a substrate is exposed by radiating an exposure light beam onto the substrate through a liquid.

### BACKGROUND ART

Semiconductor devices and liquid crystal display devices are produced by means of the so-called photolithography technique in which a pattern formed on a mask is transferred onto a photosensitive substrate. The exposure apparatus, which is used in the photolithography step, includes a mask stage for supporting the mask and a substrate stage for supporting the substrate. The pattern on the mask is transferred onto the substrate via a projection optical system while successively moving the mask stage and the substrate stage. In recent years, it is demanded to realize the higher resolution of the projection optical system in order to respond to the further advance of the higher integration of the device pattern. The shorter the exposure wavelength to be used is, the higher the resolution of the projection optical system is. The larger the numerical aperture of the projection optical system is, the higher the resolution of the projection optical system is. Therefore, the exposure wavelength, which is used for the exposure apparatus, is shortened year by year, and the numerical aperture of the projection optical system is increased as well. The exposure wavelength, which is dominantly used at present, is 248 nm of the KrF excimer laser. However, the exposure wavelength of 193 nm of the ArF excimer laser, which is shorter than the above, is also practically used in some situations. When the exposure is performed, the depth of focus (DOF) is also important in the same manner as the resolution. The resolution R and the depth of focus δ are represented by the following expressions respectively.
R=k₁·λ/NA (a)
δ=±k₂·λ/NA² (b)

In the expressions, λ represents the exposure wavelength, NA represents the numerical aperture of the projection optical system, and k₁ and k₂ represent the process coefficients. According to the expressions (a) and (b), the following fact is appreciated. That is, when the exposure wavelength λ is shortened and the numerical aperture NA is increased in order to enhance the resolution R, then the depth of focus δ is narrowed.

If the depth of focus δ is too narrowed, it is difficult to match the substrate surface with respect to the image plane of the projection optical system. It is feared that the margin is insufficient during the exposure operation. In view of the above, the liquid immersion method has been suggested, which is disclosed, for example, in International Publication No. 99/49504 as a method for substantially shortening the exposure wavelength and widening the depth of focus. In this liquid immersion method, the space between the lower surface of the projection optical system and the substrate surface is filled with a liquid such as water or any organic solvent to form a liquid immersion area so that the resolution is improved and the depth of focus is magnified about n times by utilizing the fact that the wavelength of the exposure light beam in the liquid is 1/n as compared with that in the air (n represents the refractive index of the liquid, which is about 1.2 to 1.6 in ordinary cases).

### DISCLOSURE OF THE INVENTION

The present inventors have noticed the following possibility in relation to the liquid immersion exposure apparatus. That is, the substrate and the substrate stage may be deformed merely slightly due to the weight and the pressure of the liquid of the liquid immersion area formed on the substrate and the substrate stage. There is such a possibility that the exposure accuracy and/or the measurement accuracy may be deteriorated due to the deformation. For example, when an interferometer system, which measures the position by radiating a measuring light beam onto a reflecting surface of a movement mirror provided on the substrate stage, is used when the position of the substrate stage is measured, the measurement accuracy and/or the exposure accuracy is deteriorated if the reflecting surface of the movement mirror is deformed due to the deformation of the substrate stage. Further, the following situation is also conceived. That is, the atmosphere (for example, the pressure, the humidity, and the temperature) of the substrate stage and/or any related part is changed by the supply of the liquid onto the substrate and/or the substrate stage. As a result, any influence is exerted on the exposure accuracy.

The present invention has been made taking the foregoing circumstances into consideration, an object of which is to provide an exposure apparatus, an exposure method, a position control method, and a method for producing a device, wherein it is possible to highly accurately control the position of a mover capable of holding an exposure objective substrate.

In order to achieve the object as described above, the present invention adopts the following constructions corresponding to FIGS. 1 to 14 as illustrated in embodiments. However, parenthesized symbols affixed to respective elements merely exemplify the elements by way of example, with which it is not intended to limit the respective elements.

According to a first aspect of the present invention, there is provided an exposure apparatus (EX) which exposes a substrate (P) by radiating an exposure light beam (EL) onto the substrate (P) through a liquid (LQ); the exposure apparatus comprising a mover (PST) which is capable of holding the substrate (P); an interferometer system (43) which radiates a measuring light beam (BX, BY, BXθ1, BXθ2, BYθ1, BYθ2) onto a reflecting surface (MX, MY) formed on the mover (PST) and which receives a reflected light beam therefrom to measure position information about a position of the mover (PST); and a memory (MRY) which stores, as first information, error information about an error of the reflecting surface (MX, MY) obtained in the presence of the liquid (LQ) supplied onto the mover (PST).

According to the present invention, the error information or the information about the error of the reflecting surface, which is obtained in the state in which the liquid is supplied onto the mover, is stored. Accordingly, when the interferometer system is used to measure the position information or the information about the position of the mover to which the liquid is supplied, it is possible to apply an appropriate treatment, for example, such that the measured position information about the mover is corrected on the basis of the error information. Therefore, even when the reflecting surface causes any displacement/deformation due to the supply of the liquid onto the mover, then the mover can be subjected to the position control accurately on the basis of the result of measurement performed by the interferometer system, and it is possible to satisfactorily perform the measurement process and the exposure process.

The term “error information about the reflecting surface” herein includes not only the warpage of the reflecting surface and the inclination of the reflecting surface, but also the local warpage, the inclination, and the irregularity. When the mover is constructed to have a first reflecting surface and a second reflecting surface which is substantially perpendicular to the first reflecting surface, the error information includes the orthogonality error information or the information about an error of orthogonality (perpendicularity) between the first reflecting surface and the second reflecting surface The term “error of orthogonality” herein-represents the amount of error to indicate the degree of deviation of the angle θ formed by the first reflecting surface and the second reflecting surface with respect to 90°.

According to a second aspect of the present invention, there is provided an exposure apparatus (EX) which exposes a substrate (P) by radiating an exposure light beam (EL) onto the substrate (P) through a liquid (LQ); the exposure apparatus comprising a mover (PST) which holds the substrate; a driving unit (PSTD) which moves the mover (PST); and a control unit (CONT) which controls the driving unit (PSTD) and includes first control information to move the mover (PST) in the presence of the liquid (LQ) supplied onto the mover (PST), and second control information to move the mover (PST) in the absence of the liquid (LQ) supplied onto the mover (PST).

According to the present invention, the position of the mover can be controlled highly accurately in any one of the state in which the liquid is supplied onto the mover and the state in which the liquid is not supplied onto the mover.

According to a third aspect of the present invention, there is provided a position control method for controlling a position of a mover (PST) by using a reflecting surface (MX, MY) formed on the mover (PST) which holds a substrate (P) in an exposure apparatus (EX) for exposing the substrate (P) by radiating an exposure light beam (EL) onto the substrate (P) through a liquid (LQ); the position control method comprising measuring error information about an error of the reflecting surface (MX, MY) in the presence of the liquid (LQ) supplied onto the mover (PST); and controlling the position of the mover (PST) on the basis of the error information.

According to the present invention, the error information about the reflecting surface is measured beforehand in the state in which the liquid is supplied onto the mover. Accordingly, when the position information about the mover to which the liquid is supplied is measured by using the interferometer system, it is possible to apply an appropriate treatment, for example, such that the measured position information about the mover is corrected on the basis of the error information. Therefore, the mover can be subjected to the position control accurately on the basis of the result of measurement performed by the interferometer system. It is possible to satisfactorily perform the measurement process and the exposure process.

According to a fourth aspect of the present invention, there is provided an exposure apparatus (EX2) which exposes a substrate by radiating an exposure light beam (EL) onto the substrate (P) through a liquid (LQ); the exposure apparatus (EX2) comprising an exposure station (ST2) in which the exposure light beam (EL) is radiated onto the substrate through the liquid; a measuring station (ST1) which is provided with a measuring system and in which the substrate is measured and exchanged; a mover (PST1, PST2) which is movable between the exposure station and the measuring station while holding the substrate; a driving unit (PSTD) which moves the mover; and a control unit (CONT) which controls the driving unit and includes first control information for moving the mover in the presence of the liquid supplied onto the mover, and second control information for moving the mover in the absence of the liquid supplied onto the mover; and wherein an exposure is performed for the substrate through the liquid while controlling movement of the mover on the basis of the first control information when the mover (PST1, PST2) is disposed in the exposure station (ST2), and measurement is performed while controlling the movement of the mover on the basis of the second control information when the mover is disposed in the measuring station (ST1). According to the present invention, the movement of the mover is controlled on the basis of the first control information and the second control information in the exposure station for performing the liquid immersion exposure and the measuring station for performing the measurement respectively. Therefore, the position of the mover can be controlled more correctly in response to the presence or absence of the liquid. It is possible to improve the measurement accuracy and the exposure accuracy.

According to a fifth aspect of the present invention, there is provided an exposure apparatus (EX) which exposes a substrate by radiating an exposure light beam onto the substrate through a liquid (LQ); the exposure apparatus comprising an optical member (2) through which the exposure light beam passes; a mover (PST) which is movable on a light-outgoing side of the optical member (2); an interferometer system (43) which radiates a measuring light beam onto a reflecting surface (MX, MY) formed on the mover (PST) and which receives a reflected light beam therefrom to measure position information about a position of the mover (PST); and a memory (MRY) which stores, as first information, error information about an error of the reflecting surface (MX, MY) obtained in the presence of a liquid immersion area (AR2) formed on the mover (PST).

According to the present invention, the error information about the reflecting surface obtained in the state in which the liquid immersion area is formed on the mover is stored beforehand. Accordingly, when the position information about the position of the mover to which the liquid is supplied is measured by using the interferometer system, it is possible to apply an appropriate treatment, for example, such that the measured position information about the position of the mover is corrected on the basis of the error information.

According to a sixth aspect of the present invention, there is provided an exposure method for exposing a substrate by projecting an image of a pattern onto the substrate (P) through a liquid (LQ); the exposure method comprising holding the substrate (P) or a dummy substrate on a mover (PST) provided with a reflecting surface (MX, MY) onto which a measuring light beam (BX, BY, BXθ1, BXθ2, BYθ1, BYθ2) for positional measurement; determining error information about an error of the reflecting surface in the presence of the liquid (LQ) supplied onto the mover (PST); and projecting the pattern image onto a predetermined position on the substrate through the liquid on the basis of the error information. According to the exposure method of the present invention, even when the liquid immersion exposure is performed in the state in which the liquid immersion area is formed on the mover, it is possible to correctly perform the relative positional adjustment between the pattern image and the substrate. Therefore, it is possible to maintain the high exposure accuracy brought about by the liquid immersion exposure.

According to the present invention, there is provided a method for producing a device, comprising using the exposure apparatus as defined in any one of the foregoing aspects. According to the present invention, the control can be satisfactorily performed for the position of the mover capable of holding the substrate when the exposure is performed on the basis of the liquid immersion method, and it is possible to avoid the deterioration of the exposure accuracy and the measurement accuracy. Therefore, it is possible to produce the device having the desired performance.

### BRIEF DESCRIPTION OF THE DRAWINGS

FIG. 1 shows a schematic arrangement illustrating an embodiment of an exposure apparatus according to the present invention.

FIG. 2 shows a plan view illustrating a substrate stage as viewed from an upper position.

FIG. 3 shows an arrangement of an interferometer system.

FIG. 4 shows the arrangement of the interferometer system.

FIG. 5 illustrates a procedure for measuring the surface shape of a reflecting surface.

FIG. 6 illustrates the procedure for measuring the surface shape of the reflecting surface.

FIG. 7 illustrates the procedure for measuring the surface shape of the reflecting surface.

FIG. 8 illustrates a method for measuring the surface shape of the reflecting surface.

FIG. 9 shows a flow chart illustrating an embodiment of an exposure method according to the present invention.

FIG. 10 illustrates an example of the alignment process.

FIG. 11 illustrates an example of the alignment process.

FIGS. 12(a) and 12(b) schematically illustrate the relationship between the error of the reflecting surface and the position of the liquid immersion area on the substrate stage.

FIG. 13 shows a schematic arrangement illustrating another embodiment of an exposure apparatus.

FIG. 14 shows a flow chart illustrating exemplary steps of producing a semiconductor device.

### BEST MODE FOR CARRYING OUT THE INVENTION

An explanation will be made below about the exposure apparatus according to the present invention with reference to the drawings. However, the present invention is not limited thereto.

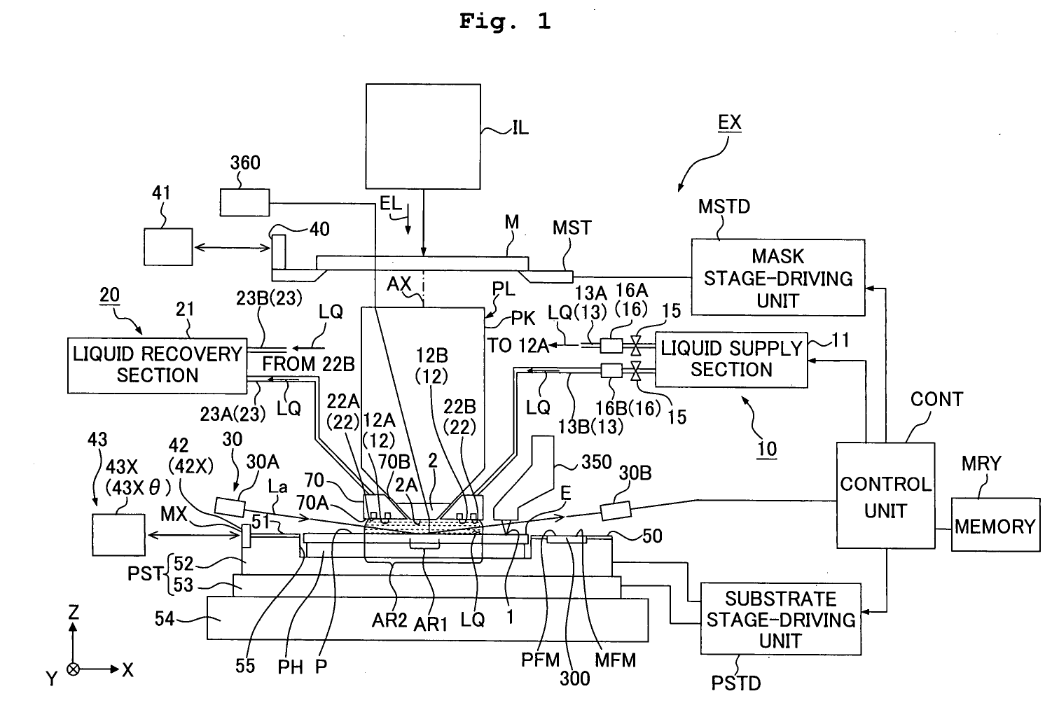

FIG. 1 shows a schematic arrangement illustrating an embodiment of the exposure apparatus of the present invention. With reference to FIG. 1, an exposure apparatus EX comprises a mask stage MST which is movable while supporting a mask M, a substrate stage PST which has a substrate holder PH for holding a substrate P and which is movable while holding the substrate P with the substrate holder PH, an illumination optical system IL which illuminates, with an exposure light beam EL, the mask M supported by the mask stage MST, a projection optical system PL which performs projection exposure for the substrate P supported by the substrate stage PST with an image of a pattern of the mask M illuminated with the exposure light beam EL, a control unit CONT which integrally controls the overall operation of the exposure apparatus EX, and a memory MRY which is connected to the control unit CONT and which stores various types of information in relation to the exposure operation.

The exposure apparatus EX of the embodiment of the present invention is the liquid immersion exposure apparatus in which the liquid immersion method is applied in order that the exposure wavelength is substantially shortened to improve the resolution and the depth of focus is substantially widened. The exposure apparatus EX comprises a liquid supply mechanism 10 which supplies the liquid LQ onto the substrate P, and a liquid recovery mechanism 20 which recovers the liquid LQ disposed on the substrate P. In the embodiment of the present invention, pure water is used as the liquid LQ. The exposure apparatus EX forms a liquid immersion area AR2 locally on at least a part of the substrate P including a projection area AR1 of the projection optical system PL by the liquid LQ supplied from the liquid supply mechanism 10 at least during the period in which the pattern image of the mask M is transferred onto the substrate P, the liquid immersion area AR2 being larger than the projection area AR1 and smaller than the substrate P. Specifically, the exposure apparatus EX is operated as follows. That is, the space between the surface (exposure surface) of the substrate P and the optical element 2 disposed at the end portion on the image plane side of the projection optical system PL is filled with the liquid LQ. The pattern image of the mask M is projected onto the substrate P to expose the substrate P therewith via the projection optical system PL and the liquid LQ disposed between the projection optical system PL and the substrate P.

The embodiment of the present invention will now be explained as exemplified by a case of the use of the scanning type exposure apparatus (so-called scanning stepper) as the exposure apparatus EX in which the substrate P is exposed with the pattern formed on the mask M while synchronously moving the mask M and the substrate P in mutually different directions (opposite directions) in the scanning directions (predetermined directions). In the following explanation, the X axis direction resides in the synchronous movement direction (scanning direction, predetermined direction) for the mask M and the substrate P in the horizontal plane, the Y axis direction (non-scanning direction) resides in the direction which is perpendicular to the X axis direction in the horizontal plane, and the Z axis direction resides in the direction which is perpendicular to the X axis direction and the Y axis direction and which is coincident with the optical axis AX of the projection optical system PL. The directions of rotation (inclination) about the X axis, the Y axis, and the Z axis are designated as θX, θY, and θZ directions respectively. The term “substrate” referred to herein includes those obtained by coating a semiconductor wafer surface with a resist, and the term “mask” includes a reticle formed with a device pattern to be subjected to the reduction projection onto the substrate.

The illumination optical system IL is provided so that the mask M, which is supported on the mask stage MST, is illuminated with the exposure light beam EL. The illumination optical system IL includes, for example, an exposure light source, an optical integrator which uniformizes the illuminance of the light flux radiated from the exposure light source, a condenser lens which collects the exposure light beam EL supplied from the optical integrator, a relay lens system, and a variable field diaphragm which sets the illumination area on the mask M illuminated with the exposure light beam EL to be slit-shaped. The predetermined illumination area on the mask M is illuminated with the exposure light beam EL having a uniform illuminance distribution by means of the illumination optical system IL. Those usable as the exposure light beam EL radiated from the illumination optical system IL include, for example, emission lines (g-ray, h-ray, i-ray) radiated, for example, from a mercury lamp, far ultraviolet light beams (DUV light beams) such as the KrF excimer laser beam (wavelength: 248 nm), and vacuum ultraviolet light beams (VUV light beams) such as the ArF excimer laser beam (wavelength: 193 nm) and the F₂ laser beam (wavelength: 157 nm). In this embodiment, the ArF excimer laser beam is used. As described above, the liquid LQ is pure water in this embodiment, through which the exposure light beam EL is transmissive even when the exposure light beam EL is the ArF excimer laser beam. The emission line (g-ray, h-ray, i-ray) and the far ultraviolet light beam (DUV light beam) such as the KrF excimer laser beam (wavelength: 248 nm) are also transmissive through pure water.

The mask stage MST is movable while holding the mask M. The mask stage MST is two-dimensionally movable in the plane perpendicular to the optical axis AX of the projection optical system PL, i.e., in the XY plane, and it is finely rotatable in the OZ direction. The mask stage MST is driven by a mask stage-driving unit MSTD such as a linear motor. The mask stage-driving unit MSTD is controlled by the control unit CONT.

A movement mirror 40, which is movable together with the mask stage, is provided on the mask stage MST. A laser interferometer 41 is provided at a position opposed to the movement mirror 40. The position in the two-dimensional direction and the angle of rotation of the mask M on the mask stage MST are measured in real-time by the laser interferometer 41. The result of the measurement is outputted to the control unit CONT. The control unit CONT drives the mask stage-driving unit MSTD on the basis of the result of the measurement obtained by the laser interferometer 41 to thereby position the mask M supported on the mask stage MST.

The projection optical system PL projects the pattern on the mask M onto the substrate P at a predetermined projection magnification β to perform the exposure. The projection optical system PL comprises a plurality of optical elements including the optical element (lens) 2 provided at the end portion on the side of the substrate P. The optical elements are supported by a barrel PK. In this embodiment, the projection optical system PL is based on the reduction system having the projection magnification β which is, for example, ¼, ⅕, or ⅛. The projection optical system PL may be based on any one of the 1× magnification system and the magnifying system. The projection optical system PL may be based on any one of the catadioptric system including dioptric and catoptric elements, the dioptric system including no catoptric element, and the catoptric system including no dioptric element. The optical element 2, which is disposed at the end portion of the projection optical system PL of this embodiment, is provided detachably (exchangeably) with respect to the barrel PK. The optical element 2, which is disposed at the end portion, is exposed from the barrel PK. The liquid LQ of the liquid immersion area AR2 makes contact with the optical element 2. Accordingly, the barrel PK composed of metal is prevented from any corrosion or the like.

The optical element 2 is formed of fluorite. Fluorite has a high affinity for pure water. Therefore, the liquid LQ is successfully allowed to make tight contact with the substantially entire surface of the liquid contact surface 2A of the optical element 2. That is, in this embodiment, the liquid (water) LQ, which has the high affinity for the liquid contact surface 2A of the optical element 2, is supplied. Therefore, the highly tight contact is effected between the liquid LQ and the liquid contact surface 2A of the optical element 2. The optical element 2 may be quartz having a high affinity for water as well. A water-attracting (lyophilic or liquid-attracting) treatment may be applied to the liquid contact surface 2A of the optical element 2 to further enhance the affinity for the liquid LQ.

The substrate stage PST comprises a Z stage 52 which holds the substrate P by the aid of the substrate holder PH, and an XY stage 53 which supports the Z stage 52. The XY stage 53 is supported on a base 54. The substrate stage PST is driven by a substrate stage-driving unit PSTD such as a linear motor. The substrate stage-driving unit PSTD is controlled by the control unit CONT. The Z stage 52 is capable of moving the substrate P held by the substrate holder PH in the Z axis direction, and in the θX and θY directions (directions of inclination). The XY stage 53 is capable of moving the substrate P held by the substrate holder PH in the XY directions (directions substantially parallel to the image plane of the projection optical system PL) and in the θZ direction by the aid of the Z stage 52. It goes without saying that the Z stage and the XY stage may be provided in an integrated manner.

A recess 55 is provided on the substrate stage PST (Z stage 52). The substrate holder PH is arranged in the recess 55. The upper surface 51 other than the recess 55 of the substrate stage PST forms a flat surface (flat section) which has approximately the same height as that of (is flush with) the surface of the substrate P held by the substrate holder PH. In this embodiment, a plate member 50, which has an upper surface 51, is arranged exchangeably on the substrate stage PST. The liquid immersion area AR2 can be satisfactorily formed while holding the liquid LQ on the image plane side of the projection optical system PL even when the edge area E of the substrate P is subjected to the liquid immersion exposure, because the upper surface 51, which is substantially flush with the surface of the substrate P, is provided around the substrate P. However, it is also allowable that any difference in height is present between the surface of the substrate P and the upper surface 51 of the plate member 50 disposed around the substrate P provided that the liquid immersion area AR2 can be satisfactorily maintained. For example, the upper surface 51 of the plate member 50 may be lower than the surface of the substrate P held by the substrate holder PH. A gap of about 0.1 to 2 mm is provided between the edge portion of the substrate P and the plate member 50 having the flat surface (upper surface) 51 provided around the substrate P. However, the liquid LQ hardly flows into the gap owing to the surface tension of the liquid LQ even when the portion, which is disposed in the vicinity of the circumferential edge of the substrate P, is subjected to the exposure.

Movement mirrors 42, each of which is movable together with the substrate stage PST with respect to the projection optical system PL, are provided on the substrate stage PST (Z stage 52). Interferometers, which constitute a laser interferometer system 43, are provided at positions opposed to the movement mirrors 42. The angle of rotation and the position in the two-dimensional direction of the substrate P on the substrate stage PST are measured in real-time by the laser interferometer system 43. The result of the measurement is outputted to the control unit CONT. The control unit CONT drives the XY stage 53 by the aid of the substrate stage-driving unit PSTD in the two-dimensional coordinate system defined by the laser interferometer system 43 on the basis of the result of the measurement of the laser interferometer system 43 to thereby position the substrate P supported by the substrate stage PST in the X axis direction and the Y axis direction.

The exposure apparatus EX includes a focus-detecting system 30 which detects the surface position information about the surface of the substrate P. The focus-detecting system 30 has a light-emitting section 30A and a light-receiving section 30B. A detecting light beam La is radiated from the light-emitting section 30A in an oblique direction (from an obliquely upward position) from the light-emitting section 30A through the liquid LQ onto the surface (exposure surface) of the substrate P. Further, the reflected light beam from the substrate P is received through the liquid LQ by the light-receiving section 30B. Accordingly, the surface position information about the surface of the substrate P is detected. The control unit CONT controls the operation of the focus-detecting system 30. Further, the control unit CONT detects the position (focus position) in the Z axis direction of the surface of the substrate P with respect to a predetermined reference surface (for example, the image plane) on the basis of the light-receiving result of the light-receiving section 30B. Further, the focus-detecting system 30 can also determine the posture of the substrate P in the direction of inclination by determining respective focus positions at a plurality of respective points on the surface of the substrate P. A system, which is disclosed, for example, in Japanese Patent Application Laid-open No. 8-37149, can be used for the focus-detecting system 30. The focus-detecting system may be such a system which detects the surface information about the surface of the substrate P without passing through the liquid LQ. In this arrangement, the surface information about the surface of the substrate P may be detected at a position separated from the projection optical system PL. An exposure apparatus, in which the surface information about the surface of the substrate P is detected at a position separated from the projection optical system PL, is disclosed, for example, in U.S. Pat. No. 6,674,510. The contents of the description in this literature are incorporated herein by reference within a range of permission of the domestic laws and ordinances of the state designated or selected in this international application.

The control unit CONT drives the Z stage 52 of the substrate stage PST by the aid of the substrate stage-driving unit PSTD to thereby control the position (focus position) in the Z axis direction and the position in the θX and θY directions of the substrate P held by the Z stage 52. That is, the Z stage 52 is operated on the basis of the instruction from the control unit CONT, based on the result of detection performed by the focus-detecting system 30. The focus position (Z position) and the angle of inclination of the substrate P are controlled so that the surface (exposure surface) of the substrate P is adjusted and matched with respect to the image plane which is formed via the projection optical system PL and the liquid LQ.

A substrate alignment system 350, which detects an alignment mark 1 disposed on the substrate P or a substrate side reference mark PFM disposed on a reference member 300 provided on the Z stage 52, is provided in the vicinity of the end portion of the projection optical system PL. The substrate alignment system 350 of this embodiment adopts the FIA (field image alignment) system in which an illumination light beam such as white light from a halogen lamp is radiated onto the mark while allowing the substrate stage PST to stand still so that an obtained image of the mark is photographed in a predetermined image pickup field by means of an image pickup element to measure the position of the mark by means of the image processing, as disclosed, for example, in Japanese Patent Application Laid-open No. 4-65603.

A mask alignment system 360, which detects a mask side reference mark MFM disposed on a reference member 300 provided on the Z stage 52 via the mask M and the projection optical system PL, is provided in the vicinity of the mask stage MST. The mask alignment system 360 of this embodiment adopts the VRA (visual reticle alignment) system in which a light beam is radiated onto the mark so that image data of the mark photographed, for example, by a CCD camera is subjected to image processing to detect the mark position, as disclosed, for example, in Japanese Patent Application Laid-open No. 7-176468.

The liquid supply mechanism 10 is provided to supply the predetermined liquid LQ to the image plane side of the projection optical system PL. The liquid supply mechanism 10 comprises a liquid supply section 11 which is capable of feeding the liquid LQ, and supply tubes 13 (13A, 13B) which have first ends connected to the liquid supply section 11. The liquid supply section 11 includes, for example, a tank for accommodating the liquid LQ, and a pressurizing pump. The liquid supply operation of the liquid supply section 11 is controlled by the control unit CONT. When the liquid immersion area AR2 is formed on the substrate P, the liquid supply mechanism 10 supplies the liquid LQ onto the substrate P. It is not necessarily indispensable that the exposure apparatus EX is provided with the tank and the pressurizing pump of the liquid supply section 11. It is also possible to make replacement with the equipment of a factory or the like in which the exposure apparatus EX is installed.

Valves 15, which open/close the flow passages of the supply tubes 13A, 13B, are provided at intermediate positions of the supply tubes 13A, 13B respectively. The opening/closing operations of the valves 15 are controlled by the control unit CONT. In this embodiment, the valve 15 is based on the so-called normally closed system in which the flow passage of the supply tube 13A, 13B is mechanically closed when the driving source (power source) of the exposure apparatus EX (control unit CONT) is stopped, for example, due to the power failure.

The liquid recovery mechanism 20 is provided to recover the liquid LQ on the image plane side of the projection optical system PL. The liquid recovery mechanism 20 comprises a liquid recovery section 21 which is capable of recovering the liquid LQ, and recovery tubes 23 (23A, 23B) which have first ends connected to the liquid recovery section 21. The liquid recovery section 21 includes, for example, a vacuum system (suction unit) such as a vacuum pump, a gas/liquid separator for separating the recovered liquid LQ from the gas, and a tank for accommodating the recovered liquid LQ. As for the vacuum system, it is also allowable that the vacuum pump is not provided for the exposure apparatus EX to use a vacuum system of a factory in which the exposure apparatus EX is installed. The liquid recovery operation of the liquid recovery section 21 is controlled by the control unit CONT. In order to form the liquid immersion area AR2 on the substrate P, the liquid recovery mechanism 20 recovers a predetermined amount of the liquid LQ disposed on the substrate P supplied from the liquid supply mechanism 10.

A flow passage-forming member 70 is arranged in the vicinity of the optical element 2 which makes contact with the liquid LQ and which is included in the plurality of optical elements for constructing the projection optical system PL. The flow passage-forming member 70 is an annular member having an opening 70B (light-transmitting section) which is formed at a central portion. The optical element 2 is accommodated in the opening 70B. That is, the flow passage-forming member 70 is provided to surround the side surface of the optical element 2 over the substrate P (substrate stage PST). A gap is provided between the flow passage-forming member 70 and the optical element 2. The flow passage-forming member 70 is supported by a predetermined support mechanism so that the flow passage-forming member 70 is separated from the optical element 2 in view of the vibration.

The following fear arises depending on the environment in which the exposure apparatus EX is installed. That is, the suction force for the liquid is increased by the liquid recovery mechanism 20 due to the change in the atmospheric pressure. As a result, the gas (air) makes contamination in the optical path for the exposure light beam EL between the projection optical system PL and the substrate P (substrate stage PST), and/or the suction force is lowered to cause the outflow or the leakage of the liquid LQ. Accordingly, it is also allowable to adopt the following means. That is, a sensor for monitoring the atmospheric pressure is installed for the exposure apparatus EX beforehand. For example, the pressure (negative pressure) of the vacuum system of the liquid recovery mechanism 20 is regulated or adjusted on the basis of the monitoring result of the sensor to regulate or adjust the suction force (recovery force) for the liquid brought about by the liquid recovery mechanism 20. In particular, when a regulator of the absolute pressure-regulating type is used to regulate the negative pressure of the vacuum system of the liquid recovery mechanism 20, it is effective to use the sensor which monitors the atmospheric pressure.

The flow passage-forming member 70 is provided with liquid supply ports 12 (12A, 12B) which are provided over the substrate P (substrate stage PST) and which are arranged opposingly to the surface of the substrate P. In this embodiment, the flow passage-forming member 70 has the two liquid supply ports 12A, 12B. The liquid supply ports 12A, 12B are provided on the lower surface 70A of the flow passage-forming member 70. The lower surface 70A, which is the liquid contact surface of the flow passage-forming member 70, is subjected to the liquid-attracting treatment to have the liquid-attracting property in the same manner as the lower surface 2A of the optical element 2.

The flow passage-forming member 70 has supply flow passages which are provided therein and which correspond to the liquid supply ports 12A, 12B. The plurality of (two) supply tubes 13A, 13B are provided to correspond to the liquid supply ports 12A, 12B and the supply flow passages. First ends of the supply flow passages of the flow passage-forming member 70 are connected to the liquid supply section 11 via the supply tubes 13A, 13B respectively. Second ends thereof are connected to the liquid supply ports 12A, 12B respectively.

Flow rate controllers 16 (16A, 16B), which are called “mass flow controllers” and which control the liquid supply amounts per unit time to be fed from the liquid supply section 11 to the liquid supply ports 12A, 12B respectively, are provided at respective intermediate positions of the two supply tubes 13A, 13B. The liquid supply amounts are controlled by the flow rate controllers 16A, 16B under the instruction signals supplied from the control unit CONT.

Further, the flow passage-forming member 70 is provided with liquid recovery ports 22 (22A, 22B) which are provided over the substrate P (substrate stage PST) and which are arranged opposingly to the surface of the substrate P. In this embodiment, the flow passage-forming member 70 has the two liquid recovery ports 22A, 22B. The liquid recovery ports 22A, 22B are provided on the lower surface 70A of the flow passage-forming member 70.

The flow passage-forming member 70 has recovery flow passages which are provided therein and which correspond to the liquid recovery ports 22A, 22B. The plurality of (two) recovery tubes 23 (23A, 23B) are provided to correspond to the liquid recovery ports 22A, 22B and the recovery flow passages. First ends of the recovery flow passages of the flow passage-forming member 70 are connected to the liquid recovery section 21 via the recovery tubes 23A, 23B respectively. Second ends thereof are connected to the liquid recovery ports 22A, 22B respectively.

The liquid supply ports 12A, 12B, which constitute the liquid supply mechanism 10, are provided at the respective positions on the both sides in the X axis direction with the projection area AR1 of the projection optical system PL intervening therebetween. The liquid recovery ports 22A, 22B, which constitute the liquid recovery mechanism 20, are provided outside the liquid supply ports 12A, 12B of the liquid supply mechanism 10 with respect to the projection area AR1 of the projection optical system PL. In this embodiment, the projection area AR1 of the projection optical system PL is established to be rectangular as viewed in a plan view, in which the Y axis direction is the longitudinal direction and the X axis direction is the transverse direction.

The operations of the liquid supply section 11 and the flow rate controllers 16 are controlled by the control unit CONT. When the liquid LQ is supplied onto the substrate P, the control unit CONT feeds the liquid LQ from the liquid supply section 11. The liquid LQ is supplied onto the substrate P from the liquid supply ports 12A, 12B provided over the substrate P via the supply tubes 13A, 13B and the supply flow passages. In this arrangement, the liquid supply ports 12A, 12B are provided on the both sides respectively while interposing the projection area AR1 of the projection optical system PL. The liquid LQ can be supplied from the both sides of the projection area AR1 by the aid of the liquid supply ports 12A, 12B. The amounts per unit time of the liquid LQ to be supplied onto the substrate P from the liquid supply ports 12A, 12B respectively can be individually controlled by the flow rate controllers 16A, 16B provided for the supply tubes 13A, 13B respectively.

The liquid recovery operation of the liquid recovery section 12 is controlled by the control unit CONT. The control unit CONT is capable of controlling the liquid recovery amount per unit time brought about by the liquid recovery section 21. The liquid LQ having been disposed on the substrate P, which is recovered from the liquid recovery ports 22A, 22B provided over the substrate P, is recovered by the liquid recovery section 21 via the recovery tubes 23A, 23B and the recovery flow passages of the flow passage-forming member 70.

In this embodiment, the supply tubes 13A, 13B are connected to one liquid supply section 11. However, a plurality of (for example, two) liquid supply sections 11 may be provided corresponding to the number of the supply tubes. The respective supply tubes 13A, 13B may be connected to the plurality of liquid supply sections 11 respectively. Further, the recovery tubes 23A, 23B are connected to one liquid recovery section 21. However, a plurality of (for example, two) liquid recovery sections 21 may be provided corresponding to the number of the recovery tubes. The respective recovery tubes 23A, 23B may be connected to the plurality of liquid recovery sections 21 respectively. The liquid recovery port may be provided to surround the projection area AR1 of the projection optical system PL and the liquid supply ports 12A, 12B.

The lower surface (surface directed toward the substrate P) 70A of the flow passage-forming member 70 is a substantially flat surface. The lower surface (liquid contact surface) 2A of the optical element 2 is a flat surface as well. The lower surface 70A of the flow passage-forming member 70 is substantially flush with the lower surface 2A of the optical element 2. Accordingly, it is possible to satisfactorily form the liquid immersion area AR2 in a wide range.

The mechanism, which forms the liquid immersion area AR2 on the object (for example, the substrate P) opposed to the projection optical system PL, is not limited to the above. For example, it is possible to use a mechanism disclosed in United States Patent Publication No. 2004/0207824. The contents of the description in this literature are incorporated herein by reference within a range of permission of the domestic laws and ordinances of the state designated or selected in this international application.

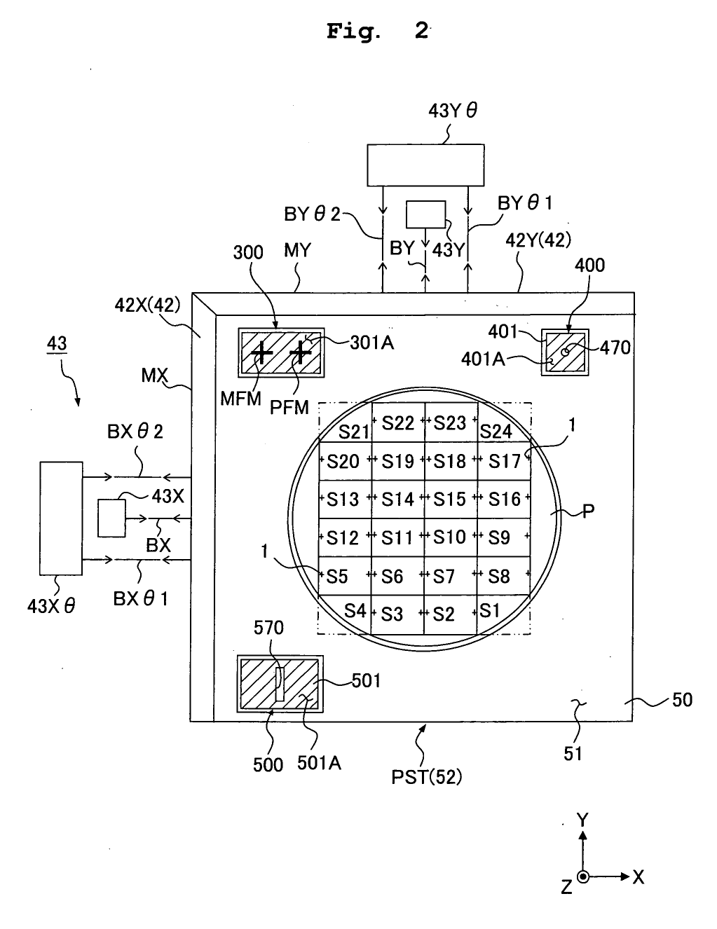

FIG. 2 shows a plan view as viewed from an upper position, illustrating the substrate stage PST as the mover which is movable while holding the substrate P. With reference to FIG. 2, the movement mirrors 42 (42X, 42Y) are arranged at the mutually perpendicular two edges of the substrate stage PST which is rectangular as viewed in a plan view.

The upper surface 51 of the substrate stage PST is subjected to the liquid-repelling treatment to have the liquid repellence. As for the liquid-repelling treatment for the upper surface 51, for example, a liquid-repellent material including, for example, fluorine-based resin materials and acrylic resin materials is applied, or a thin film composed of the liquid-repellent material as described above is stuck. A material, which is insoluble in the liquid LQ, is used as the liquid-repellent material in order to provide the liquid repellence. All or a part of the substrate stage PST may be formed of a material having the liquid repellence represented by the fluorine-based resin including, for example, polytetrafluoroethylene (Teflon (trade name)). Further, the plate member 50 may be formed of a material having the liquid repellence composed of, for example, polytetrafluoroethylene.

The reference member 300 is arranged at a predetermined position outside the substrate P on the substrate stage PST. The reference mark PFM to be detected by the substrate alignment system 350 (FIG. 1) and the reference mark MFM to be detected by the mask alignment system 360 (FIG. 1) are provided in a predetermined positional relationship on the reference member 300. The upper surface 301A of the reference member 300 is a substantially flat surface. The upper surface 301A is provided to have approximately the same height as those of (be flush with) the surface of the substrate P held by the substrate stage PST and the upper surface 51 of the substrate stage PST. The upper surface 301A of the reference member 300 can also play a role of the reference surface for the focus-detecting system 30.

The substrate alignment system 350 (FIG. 1) also detects the alignment marks 1 formed on the substrate P. As shown in FIG. 2, a plurality of shot areas S1 to S24 are formed on the substrate P. The plurality of alignment marks 1 are provided on the substrate P corresponding to the plurality of shot areas S1 to S24. In FIG. 2, the respective shot areas are depicted as if they are disposed adjacently to one another. However, the respective shot areas are actually separated from each other. The alignment marks 1 are provided on scribe lines as separation areas thereof.

An uneven illuminance sensor (a dose uniformity sensor) 400, which is disclosed, for example, in Japanese Patent Application Laid-open No. 57-117238, is arranged as a measuring sensor at a predetermined position outside the substrate P on the substrate stage PST. The uneven illuminance sensor 400 is provided with an upper plate 401 which is rectangular as viewed in a plan view. The upper surface 401A of the upper plate 401 is a substantially flat surface, which is provided to have approximately the same height as those of (be flush with) the surface of the substrate P held by the substrate stage PST and the upper surface 51 of the substrate stage PST. A pinhole section 470, through which the light is transmissive, is provided through the upper surface 401A of the upper plate 401. Portions of the upper surface 401A other than the pinhole section 470 are coated with a light-shielding material such as chromium.

A spatial image-measuring sensor (an aerial image-measuring sensor) 500, which is disclosed, for example, in Japanese Patent Application Laid-open No. 2002-14005, is provided as a measuring sensor at a predetermined position outside the substrate P on the substrate stage PST. The spatial image-measuring sensor 500 is provided with an upper plate 501 which is rectangular as viewed in a plan view. The upper surface 501A of the upper plate 501 is a substantially flat surface. The upper surface 501A of the upper plate 501 is provided to have approximately the same height as those of (be flush with) the surface of the substrate P held by the substrate stage PST and the upper surface 51 of the substrate stage PST. A slit section 570, through which the light is transmissive, is provided through the upper surface 501A of the upper plate 501. Portions of the upper surface 501A other than the slit section 570 are coated with a light-shielding material such as chromium.

Although not shown, a radiation amount sensor (illuminance sensor, dose sensor), which is disclosed, for example, in Japanese Patent Application Laid-open No. 11-16816, is also provided on the substrate stage PST. The upper surface of the upper plate of the radiation amount sensor is provided to have approximately the same height as those of (be flush with) the surface of the substrate P held by the substrate stage PST and the upper surface 51 of the substrate stage PST.

As described above, the upper surface 51 of the substrate stage PST has approximately the same height (is flush) while including, for example, the reference member 300, the uneven illuminance sensor 400, and the spatial image-measuring sensor 500. The substrate stage PST can be moved in a wide range in the state in which the liquid LQ is held between the optical element 2 of the projection optical system PL and the upper surface 51 of the substrate stage PST.

For example, the reference member 300 and the upper plates 401, 501 are detachable (exchangeable) with respect to the substrate stage PST.

The surfaces of the reference member 300 and the upper plates 401, 501 are also liquid-repellent. Even when the liquid immersion area is formed on these surfaces, the liquid can be recovered with ease.

The measuring member, which is carried on the substrate stage PST, is not limited to those described above. It is possible to carry, for example, a sensor for measuring the wavefront aberration of the projection optical system PL, if necessary. It is of course allowable that no measuring member is carried on the substrate stage PST.

The X movement mirror 42X which is formed in the Y axis direction and which has the reflecting surface MX substantially perpendicular to the X axis direction, and the Y movement mirror 42Y which is formed in the X axis direction and which has the reflecting surface MY substantially perpendicular to the Y axis direction are provided respectively at the end on the −X side and the end on the +Y side of the substrate stage PST which is rectangular as viewed in a plan view respectively. The interferometer 43X, which constitutes the laser interferometer system 43, is provided at the position opposed to the reflecting surface MX of the movement mirror 42X. Further, the interferometer 43Y, which constitutes the laser interferometer system 43, is provided at the position opposed to the reflecting surface MY of the movement mirror 42Y. A length-measuring beam BX, which is emitted from the interferometer 43X to detect the position (distance change) in the X axis direction, is radiated perpendicularly onto the reflecting surface MX of the movement mirror 42X. A length-measuring beam BY, which is emitted from the interferometer 43Y to detect the position (distance change) in the Y axis direction, is radiated perpendicularly onto the reflecting surface MY of the movement mirror 42Y. The optical axis of the length-measuring beam BX is parallel to the X axis direction, and the optical axis of the length-measuring beam BY is parallel to the Y axis direction. The both cross perpendicularly to one another (cross at right angles) on the optical axis AX of the projection optical system PL (FIG. 1).

The X axis θ interferometer 43Xθ, which constitutes the laser interferometer system 43, is provided at the position opposed to the reflecting surface MX of the movement mirror 42X. Two beams BXθ1, BXθ2, which are separated from each other by a predetermined spacing distance in the Y axis direction and which are parallel to one another in the X axis direction, are radiated perpendicularly from the X axis θ interferometer 43Xθ onto the reflecting surface MX of the movement mirror 42X respectively. The X axis θinterferometer 43Xθ measures the mutual difference in the optical path between the beams BXθ1, BXθ2 by receiving the reflected light beams thereof. Further, the X axis θ interferometer 43Xθ measures the amount of rotation (inclination) of the movement mirror 42X within a ranged defined by the spacing distance between the two beams BXθ1, BXθ2 in the Y axis direction.

The Y axis θ interferometer 43Yθ, which constitutes the laser interferometer system 43, is provided at the position opposed to the reflecting surface MY of the movement mirror 42Y. Two beams BYθ1, BYθ2, which are separated from each other by a predetermined spacing distance in the X axis direction and which are parallel to one another in the Y axis direction, are radiated perpendicularly from the Y axis θ interferometer 43Yθonto the reflecting surface MY of the movement mirror 42Y respectively. The Y axis θ interferometer 43Yθmeasures the mutual difference in the optical path between the beams BYθ1, BYθ2 by receiving the reflected light beams thereof. Further, the Y axis θ interferometer 43Yθ measures the amount of rotation (inclination) of the movement mirror 42Y within a ranged defined by the spacing distance between the two beams BYθ1, BYθ2 in the X axis direction.

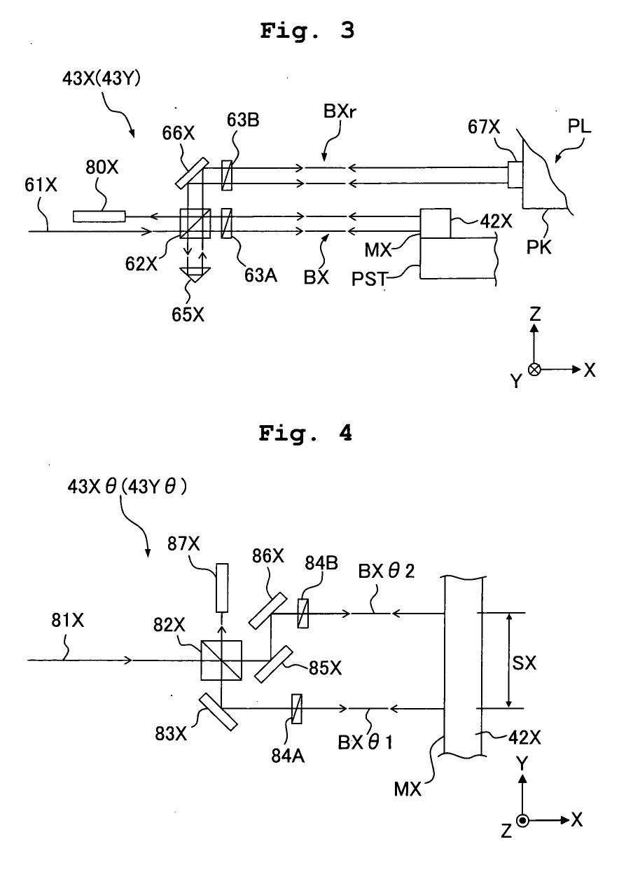

FIG. 3 shows an example of the arrangement of the interferometer 43X as viewed in the Y axis direction (from the −Y side). The interferometer 43X comprises, for example, an unillustrated light source, a polarizing beam splitter 62X which is arranged on the optical path of a laser beam 61X radiated from the light source, a mirror 66X which is provided obliquely at an angle of inclination of 45° with respect to the XY plane on the +Z side of the beam splitter 62X, a ¼ wavelength plate (hereinafter referred to as “λ/4 plate”) 63B which is arranged on the +X side of the mirror 66X, a λ/4 plate 63A which is arranged on the +X side the beam splitter 62X, a corner cube 65X which is arranged on the −Z side of the beam splitter 62X, and a receiver 80X which is arranged on the −X side of the beam splitter 62X.

The interferometer 43X is operated as follows. That is, the He—Ne laser beam 61X, which is radiated from the unillustrated light source, which involves the difference in the frequency, and which includes mutually perpendicular components (P-polarized light component and S-polarized light component), is allowed to come into the polarizing beam splitter 62X where the laser beam 61X is divided, depending on the direction of polarization, into the beam (i.e., the length-measuring beam described above) BX which is directed to the reflecting surface MX and the beam (hereinafter referred to as “reference beam”) BXr which is directed to the reference mirror (fixed mirror) 67X fixed to the barrel PK of the projection optical system PL via the mirror 66X. The reference beam BXr (S-polarized light beam), which is reflected by the beam splitter 62X, is reflected by the mirror 66X, and the reference beam BXr passes through the λ/4 plate 63B to form the circularly polarized light beam which is radiated onto the lower half of the reference mirror 67X. The reference beam BXr (circularly polarized light beam) is reflected by the reference mirror 67X, and it is returned in the opposite direction along the original optical path. In this situation, the reflected light beam, which is reflected by the reference mirror 67X, passes through the λ/4 plate 63B again, and thus the light beam is converted into the P-polarized light beam having the direction of polarization perpendicular to the incoming light beam (feed light). The light beam is reflected by the mirror 66X, and then the light beam passes through the polarizing beam splitter 62X to arrive at the corner cube 65X. The reference beam BXr (P-polarized light beam) is reflected by the reflecting surface of the corner cube 65X, and it is bent and returned in the opposite direction. The light beam passes through the beam splitter 62X again, and it successively passes through the mirror 66X and the λ/4 plate 63B. During this process, the light beam is converted into the circularly polarized light beam which arrives at the upper half of the reference mirror 67X. The reference beam BXr (circularly polarized light beam), which is reflected by the reference mirror 67X, is converted into the S-polarized light beam when the reference beam BXr passes through the λ/4 plate 63B again. The light beam is successively reflected by the mirror 66X and the polarizing beam splitter 62X, and the light beam comes into the receiver 80X.

On the other hand, the length-measuring beam BX (P-polarized light beam), which has passed through the beam splitter 62X, passes through the λ/4 plate 63A, and the length-measuring beam BX is converted into the circularly polarized light beam which is thereafter radiated onto the lower half of the reflecting surface MX of the movement mirror 42X. The length-measuring beam BX (circularly polarized light beam), which is reflected by the reflecting surface MX, passes through the λ/4 plate 63A, and it is converted into the S-polarized light beam. The light beam is reflected downwardly by the beam splitter 62X. The light beam is reflected by the reflecting surface of the corner cube 65X, and it is bent and returned in the opposite direction. The light beam is reflected by the beam splitter 62X again. The light beam passes through the λ/4 plate 63A, and it is converted into the circularly polarized light beam which is radiated onto the upper half of the reflecting surface MX. The length-measuring beam BX (circularly polarized light beam), which is reflected by the reflecting surface MX, passes through the λ/4 plate 63A, and it is converted into the P-polarized light beam. The light beam passes through the beam splitter 62X, and it is coaxially combined with the reference beam BXr (S-polarized light beam) to come into the receiver 80X. The receiver 80X causes the mutual interference while adjusting the direction of polarization for the reflected light beam (length-measuring beam BX (P-polarized light beam)) allowed to come from the reflecting surface MX of the movement mirror 42X and the reflected light beam (reference beam BXr (S-polarized light beam)) allowed to come from the reference mirror 67X. The difference in the frequency between the reflected beams (substantially the same beams as the mutually perpendicular polarized light components having the difference in the frequency contained in the laser beam 61X radiated from the light source) is utilized to detect the difference in the optical path length (difference in the optical path) between the two optical paths (optical path for the length-measuring beam BX and the optical path for the reference beam BXr) in accordance with the heterodyne system. The detection of the difference in the optical path as described above is performed depending on the change of the position of the movement mirror 42X (reflecting surface MX) in the X axis direction. Accordingly, the change of the difference in the optical path between the length-measuring beam BX and the reference beam BXr is consequently detected.

The interferometer 43Y is also constructed to include, for example, a beam splitter, a mirror, a receiver, and a λ/4 plate in the same manner as the interferometer 43X described above, which has the arrangement equivalent to that of the interferometer 43X explained with reference to FIG. 3. Therefore, any explanation thereof is omitted.

FIG. 4 shows a schematic arrangement of the θ interferometer 43Xθ. With reference to FIG. 4, the θ interferometer 43Xθ comprises, for example, an unillustrated light source, a polarizing beam splitter 82X which is arranged on the optical path for a laser beam 81X radiated from the light source, a mirror 85X which is provided obliquely at an angle of inclination of 45° with respect to the XZ plane on the +X side of the beam splitter 82X, a mirror 86X which is provided obliquely in the same manner as the mirror 85X on the +Y side of the mirror 85X, a λ/4 plate 84B which is arranged on the +X side of the mirror 86X, a mirror 83X which is arranged in the direction perpendicular to the direction of the mirror 85X on the −Y side of the beam splitter 82X, a λ/4 plate 84A which is arranged on the +X side of the mirror 83X, and a receiver 87X which is arranged on the +Y side of the beam splitter 82X.

The θ interferometer 43Xθ is operated as follows. That is, the He—Ne laser beam 81X, which is radiated from the unillustrated light source, which involves the difference in the frequency, and which includes mutually perpendicular components (P-polarized light component and S-polarized light component), is branched into two by being reflected by or transmitted through the polarizing beam splitter 82X. The S-polarized light beam, which is reflected by the beam splitter 82X, is reflected by the mirror 83X, and the light beam passes through the λ/4 plate 84A to be converted into the circularly polarized light beam BXθ1 which is radiated perpendicularly onto one point of the reflecting surface MX of the movement mirror 42X. The P-polarized light beam, which is transmitted through the beam splitter 82X, is successively reflected by the mirrors 85X, 86X, and then the light beam passes through the λ/4 plate 84B to be converted into the circularly polarized light beam BXθ2 which is radiated perpendicularly onto another point of the reflecting surface MX. In this arrangement, the beam BXθ1 and the beam BXθ2 are parallel to the X axis. The spacing distance in the Y axis direction therebetween is set to SX (about 10 mm to several tens mm) on the reflecting surface of the movement mirror MX.

The beam BXθ1 (circularly polarized light beam), which is reflected by the reflecting surface MX of the movement mirror 42X, is transmitted through the λ/4 plate 84A again, and the light beam is converted into the P-polarized light beam which is thereafter reflected by the mirror 83X. Further, the light beam is transmitted through the beam splitter 82X to come into the receiver 87X. On the other hand, the beam BXθ2 (circularly polarized light beam), which is reflected by the reflecting surface MX, is transmitted through the λ/4 plate 84B again, and the light beam is converted into the S-polarized light beam which is thereafter reflected by the mirrors 86X, 85X successively. The light beam arrives at the beam splitter 82X. The light beam (S-polarized light beam) is reflected by the beam splitter 82X, and the light beam is coaxially combined with the P-polarized light beam described above to come into the receiver 87X.

The receiver 87X causes the mutual interference while adjusting the direction of polarization for the reflected light beam (P-polarized light beam) of the beam BXθ1 allowed to come and the reflected light beam (S-polarized light beam) of the beam BXθ2 allowed to come. The difference in the frequency between the reflected beams (substantially the same beams as the mutually perpendicular polarized light components having the difference in the frequency contained in the laser beam 81X radiated from the light source) is utilized to detect the difference in the optical path length (difference in the optical path) between the two optical paths (optical path for the beam BXθ1 and the optical path for the beam BXθ2) in accordance with the heterodyne system. The detection of the difference in the optical path as described above is performed depending on the change of the posture of the movement mirror 42X (reflecting surface MX) in the θZ direction. Accordingly, the change of the difference in the optical path between the beam BXθ1 and the beam BXθ2 is consequently detected.

Although omitted in the foregoing explanation, the difference in the optical path is actually measured at two points on the reflecting surface MX of the movement mirror 42X on the basis of the reference mirror (fixed mirror) in the same manner as in the interferometer 43X and the interferometer 43Y, in relation to the θ interferometer 43Xθ as well.

The other θ interferometer 43Yθ is also constructed to include, for example, a beam splitter, a mirror, a receiver, and a λ/4 plate in the same manner as the θ interferometer 43Xθ described above, which has the arrangement equivalent to that of the θ interferometer 43Xθ explained with reference to FIG. 4. Therefore, any explanation about the specified arrangement thereof is omitted.

The arrangements of the respective interferometers described above are provided by way of example. It is also possible to adopt another arrangement. In principle, it is enough to determine the amount of change of the difference in optical path between the two beams BX, BXr and the amount of change of the difference in optical path between the two beams BXθ1, BXθ2. For example, the following arrangement is also available. That is, a pair of interferometers, which are constructed in the same manner as the interferometer 43X or 43Y, are arranged corresponding to the reflecting surfaces MX, MY of the movement mirrors 42X, 42Y respectively so that their length-measuring axes are separated by the spacing distance as described above, in place of the θinterferometers 43Xθ, 43Yθ. The amounts of local rotation of the reflecting surfaces of the movement mirrors 42X, 42Y (reflecting surfaces MX, MY) and the amount of rotation (yawing) of the substrate stage PST are determined from the measuring axes and the spacing distance. In this arrangement, only the pair of interferometers may be used for the X axis and the Y axis respectively. It is also allowable that the interferometers 43X, 43Y are not provided. It is not necessarily indispensable that the reference mirror 67X or the like as described above is not provided for the projection optical system PL. It is also allowable to add an interferometer or interferometers to be used for the measurement of the amount of rotation (rolling amount) in the θX direction and/or the amount of rotation (pitching amount) in the θY direction of the substrate stage PST.

The measurement signals (detection signals), which are supplied from the respective receivers of the interferometers 43X, 43Y, 43Xθ, 43Yθ described above, are outputted to the control unit CONT.

In the exposure apparatus EX of this embodiment, the substrate P completed for the exposure is exchanged with the substrate P as the next exposure objective on the substrate stage PST by means of an unillustrated substrate exchange mechanism at the stage at which the exposure is completed for the substrate P on the substrate stage PST.

In the exposure apparatus EX of this embodiment, every time when the substrate P is exchanged at intervals of every predetermined number of sheets, for example, at every 1 lot (1 lot includes, for example, 25 sheets or 50 sheets), i.e., when the exposure is completed for the final substrate P included in 1 lot, and the substrate P is exchanged with the substrate P disposed at the head of the next lot, then the control unit CONT is operated to measure the surface shapes of the reflecting surfaces MX, MY of the movement mirrors 42X, 42Y on the substrate stage PST.

An explanation will be made below about an example of the method for measuring the surface shapes (irregularities, inclinations) of the reflecting surfaces MX, MY.

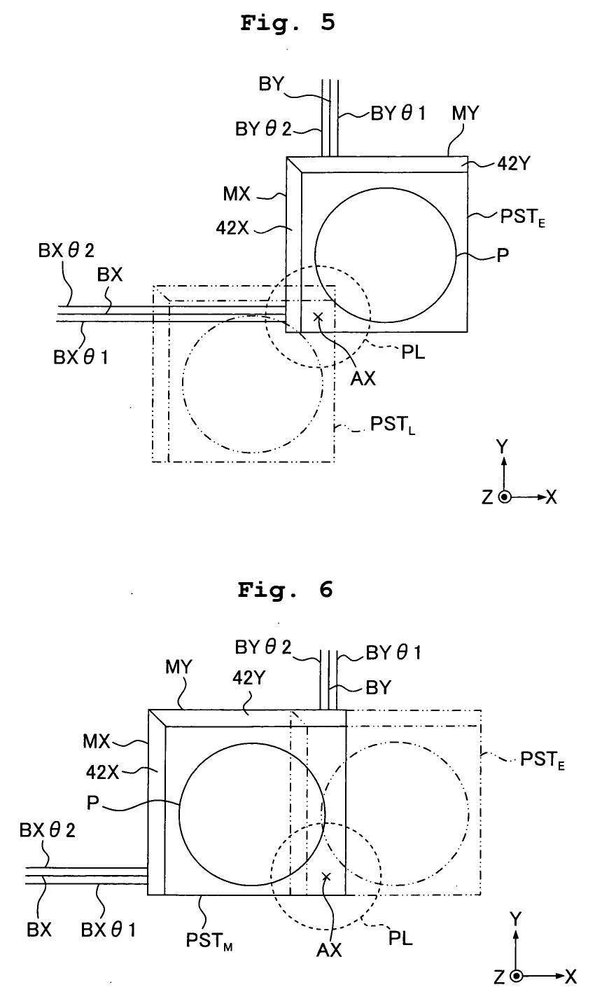

With reference to FIG. 5, for example, the substrate stage PST, which is located at the position (exposure completion position) provided when the exposure operation is completed for the substrate P on the substrate stage PST, is depicted by the symbol PST_{E}, and the substrate stage PST, which is located at the position (substrate exchange position) for performing the substrate exchange, is depicted by the symbol PST_{L}. In the following explanation, the exposure completion position is referred to as “exposure completion position PST_{E}”, and the substrate exchange position is referred to as “substrate exchange position PST_{L}” for the convenience of the explanation.

In the exposure apparatus EX of this embodiment, all of the liquid LQ, which has been disposed on the substrate P or on the substrate stage PST, is recovered after the completion of the exposure for the final substrate P of the previous lot to provide the dry state.

In the exposure apparatus EX of this embodiment, the movement of the substrate stage PST from the exposure completion position PST_{E} to the substrate exchange position PST_{L} and the movement from the substrate exchange position PST_{L} to the exposure start position are performed along the routes in which the distance of the movement of the substrate stage PST is substantially the shortest in the same manner as in the ordinary operation when the substrate is exchanged except when the final substrate P of the previous lot is exchanged with the head substrate P of the next lot (hereinafter appropriately referred to as “when the substrate at the head of the lot is exchanged”).

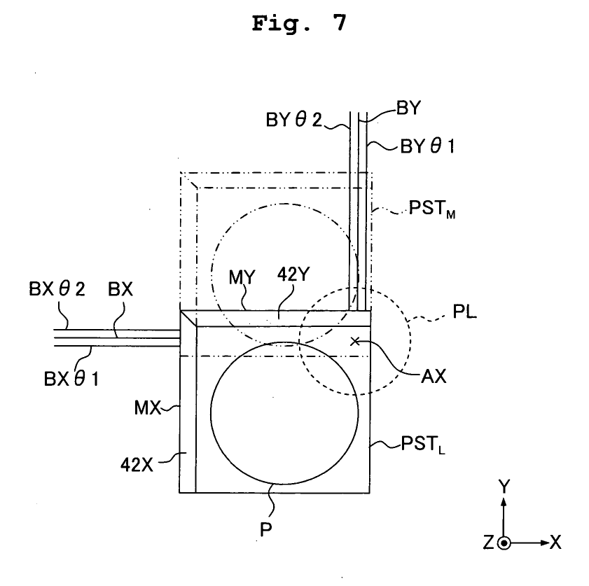

On the other hand, as shown in FIG. 6, when the substrate disposed at the head of the lot is exchanged, the substrate stage PST is firstly moved in the X axis direction by the control unit CONT from the exposure completion position PST_{E} to the intermediate position indicated by the symbol PST_{M} (hereinafter appropriately referred to as “intermediate position PST_{M}”) between the exposure completion position PST_{E} and the substrate exchange position PST_{L}. All of the liquid LQ having been disposed on the substrate stage PST is recovered at the exposure completion position PST_{E}.

During the movement, the data, which is required to calculate the surface shape of the reflecting surface MY in the dry state of the movement mirror 42Y, is obtained by the control unit CONT.

That is, the control unit CONT moves the substrate stage PST in the −X direction from the exposure completion position PST_{E} to the intermediate position PST_{M} as described above while monitoring the measured values of the interferometers 43X, 43Y. The movement is performed in an order of the acceleration after the start of the movement, the constant velocity movement, and the deceleration immediately before the completion of the movement. In this procedure, the acceleration region and the deceleration region are provided in slight amounts, and almost all of the movement resides in the constant velocity region.

During the movement of the substrate stage PST as described above, the control unit CONT samples the measured values of the interferometers 43Yθ, 43Xθ in synchronization with the timing of the sampling performed every predetermined number of times for the measured values of the interferometer 43X to calculate the irregularity amount or the concave/convex amount (inclination data) in order to calculate the surface shape of the reflecting surface MY of the movement mirror 42Y as follows.

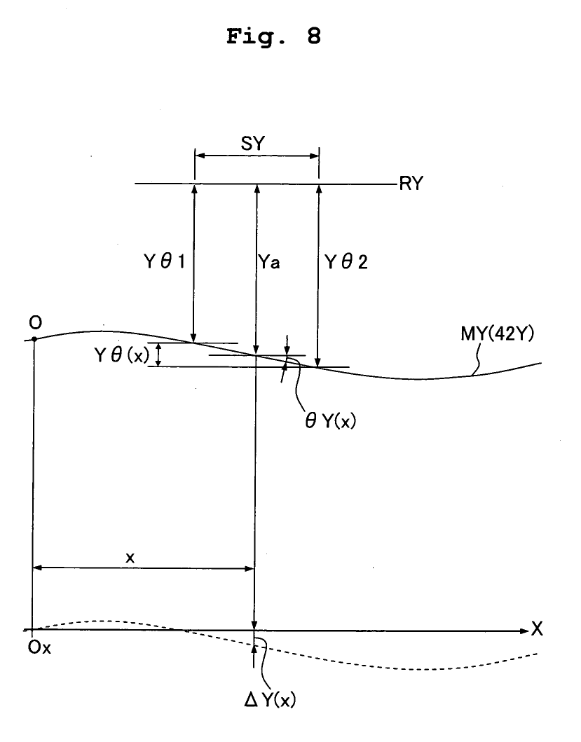

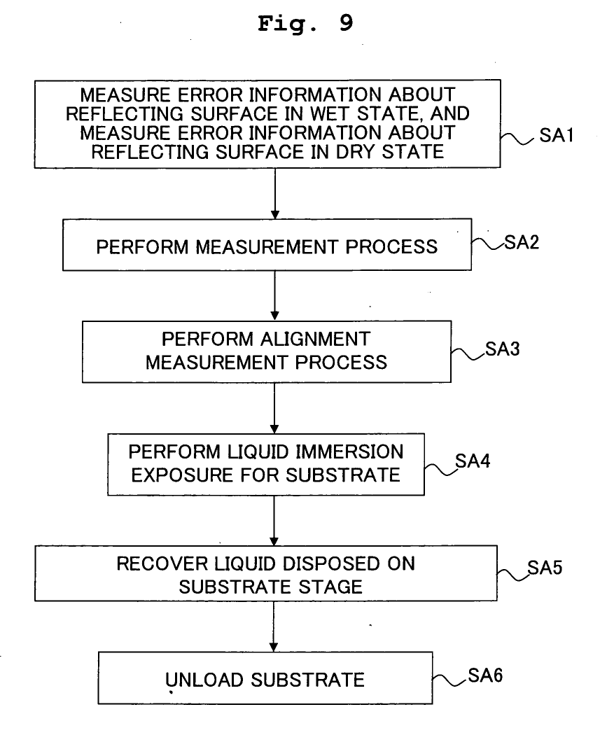

An explanation will be made below about the method for calculating the irregularity amount of the reflecting surface MY with reference to FIG. 8.

As described above, the θ interferometers actually measures the amounts of rotation of the reflecting surfaces MX, MY of the movement mirrors 42X, 42Y on the basis of the fixed mirror (reference mirror as described above). However, in order to simplify the explanation, as shown in FIG. 8, the explanation will be made assuming that the θ interferometer 43Yθdetects, as the error information, the local inclination (amount of rotation and/or amount of warpage) of the movement mirror 42Y (reflecting surface MY) on the basis of the reference line RY fixed in a virtual manner.

In FIG. 8, it is assumed that Ya (value to be measured by the interferometer 43Y) represents the distance between the reference line RY and the reflecting surface MY of the movement mirror 42Y, and θY(x) represents the amount of local rotation (angle of inclination, angle of warpage) of the reflecting surface MY (movement mirror 42Y) at that position. The θ interferometer 43Yθmeasures the distances Yθ1, Yθ2 ranging to the reflecting surface MY at the two points which are separated from each other by SY in the X axis direction on the reference line RY to measure the difference Yθ(x) between the both distances. That is, the difference Yθ(x) represented by the following expression (1) is measured.
Yθ(x)=Yθ2−Yθ1 (1)

It is assumed that the control unit CONT starts the measurement when the reflecting surface MY of the movement mirror 42Y is disposed at the reference point Ox in the X axis direction, i.e., from the point of time at which the length-measuring beam BY of the interferometer 43Y is allowed to come into the fixed point O on the reflecting surface MY. The point of time is the point of time at which the substrate stage PST completes the acceleration. In this situation, it is assumed that the control unit CONT resets, to zero, both of the measured values of the interferometer 43X and the θ interferometer 43Xθ. The situation of the reset is visually illustrated in the lower half of FIG. 8.

In this situation, the amount of local rotation (angle of inclination) θY(x) of the movement mirror is at most a minute angle of about 1 to 2 seconds, and the spacing distance SY is from 100 mm to several tens mm. Therefore, the angle of inclination θY(x) can be approximated by the following expression (2) in accordance with tan θY(x)=Yθ(x)/SY.
θY(x)=Yθ(x)/SY (2)

On the other hand, the irregularity amount ΔY(x), which is on the basis of the Y coordinate value of the reflecting surface at the position Ox of the reflecting surface MY (ΔY(x)=0), can be determined by the following expression (3) assuming that the reference point Ox resides in x=0.
ΔY(x)=∫₀^{x}θY(x)dx (3)

However, actually, for example, any yawing may arise in the substrate stage PST during the movement. Therefore, ΔY(x) includes the amount of error caused by the yawing amount as well as the irregularity caused by the inclination of the reflecting surface MY of the movement mirror 42Y. Therefore, it is necessary that the amount of error caused by the yawing amount should be subtracted from the value determined by the expression (3).

In this arrangement, the substrate stage PST merely performs the one-dimensional movement in the X axis direction. Therefore, the two beams BXθ1, BXθ2 of the θ interferometer 43Xθ are continuously radiated onto the substantially same points on the reflecting surface MX of the movement mirror 42X. In this situation, the measured value of the θ interferometer 43Xθ is reset at the reference point Ox as described above. Therefore, the value of the θ interferometer 43Xθ at the position x is the yawing amount Xθ(x) of the substrate stage PST on the basis of the reference point Ox.

In view of the above, the correcting calculation as represented by the following expression (4) is performed by using the measured value Xθ(x) obtained by the θ interferometer 43Xθ corresponding to the measured value θY(x) of the θ interferometer 43Yθused to calculate the irregularity amount ΔY(x) of the reflecting surface. Accordingly, the true irregularity amount DY1(x) of the reflecting surface MY of the movement mirror 42Y is determined.
DY1(x)=∫₀^{x}θY(x)dx−∫₀^{x}Xθ(x)dx (4)

The control unit CONT performs the calculation of the expression (4) every time when the data θY(x) and the data Xθ(x) are subjected to the sampling. The irregularity amount DY1(x) in the dry state of the reflecting surface MY of the movement mirror 42Y corresponding to each of the sampling points is stored in the memory MRY.

In this procedure, it is assumed that the final sampling data, which is the objective of the calculation of the expression (4) described above, is the data corresponding to x=L. It is assumed that the point of time, at which x=L is provided, is coincident with the point at which the substrate stage PST starts the deceleration.

As described above, when the error information about the reflecting surface MY provided substantially in the X axis direction is measured, the substrate stage PST is moved to a plurality of positions in the Y axis direction to measure a plurality of pieces of information corresponding to the plurality of positions in the state (dry state) in which the liquid immersion area AR2 is not formed on the substrate stage PST. Accordingly, it is possible to measure the error information in the dry state of the reflecting surface MY. As described above, the plurality of beams BY, BYθ1, BYθ2, which are substantially parallel to the Y axis direction, are radiated onto the reflecting surface MY from the interferometers 43Y, 43Yθ provided to measure the position information about the substrate stage PST during the movement of the substrate stage PST in the X axis direction. Further, the reflected light beams from the reflecting surface MY are received. Accordingly, the control unit CONT can efficiently measure the error information about the reflecting surface MY on the basis of the light-receiving result of the receiver.

Subsequently, as shown in FIG. 7, the control unit CONT moves the substrate stage PST in the −Y direction from the intermediate position PST_{M} to the substrate exchange position PST_{L} while monitoring the measured values of the interferometers 43X, 43Y (FIG. 2). Also in this procedure, the movement is performed in an order of the acceleration after the start of the movement, the constant velocity movement, and the deceleration immediately before the completion of the movement. In this procedure, the acceleration region and the deceleration region are provided in slight amounts, and almost all of the movement resides in the constant velocity region.

During the movement of the substrate stage PST as described above, the control unit CONT simultaneously samples the measured values of the interferometers 43Yθ, 43Xθ in synchronization with the timing of the sampling performed every predetermined number of times for the measured values of the interferometer 43Y to calculate the irregularity amount data (inclination data) of the reflecting surface MX of the movement mirror 42X in the same manner as described above every time when the sampling is performed.

That is, assuming that the measured value of the θ interferometer 43Xθ is Xθ(y), and the spacing distance between the two beams of the θ interferometer 43Xθ is SX (see FIG. 4), the control unit CONT calculates the amount of local rotation of the reflecting surface, i.e., the angle of inclination (angle of warpage) θX(y) in accordance with the following expression (5). Further, assuming that the measured value of the θ interferometer 43Yθ is Yθ(y), the control unit CONT determines the irregularity amount DX1(y) of the reflecting surface MX of the movement mirror 42X on the basis of the following expression (6).
θx(y)=xθ(y)/SX (5)
DX1(y)=∫₀^{y}θX(y)dy−∫₀^{y}Yθ(y)dy (6)

As described above, the control unit CONT determines the irregularity amount DX1(y) in the dry state of the reflecting surface MX of the movement mirror 42X corresponding to each of the sampling points, and the irregularity amount DX1(y) is stored in the memory MRY.

In this procedure, it is assumed that the final sampling data, which is the objective of the calculation of the expression (6), is the data corresponding to y=L′. It is assumed that the point of time, at which y=L′ is provided, is coincident with the point at which the substrate stage PST starts the deceleration.

As described above, when the error information about the reflecting surface MX provided substantially in the Y axis direction is measured, the substrate stage PST is moved to a plurality of positions in the X axis direction to measure a plurality of pieces of information corresponding to the plurality of positions in the state (dry state) in which the liquid immersion area AR2 is not formed on the substrate stage PST. Accordingly, it is possible to measure the error information in the dry state of the reflecting surface MX. As described above, the plurality of beams BX, BXθ1, BXθ2, which are substantially parallel to the X axis direction, are radiated onto the reflecting surface MX from the interferometers 43X, 43Xθ provided to measure the position information about the substrate stage PST during the movement of the substrate stage PST in the Y axis direction. Further, the reflected light beams from the reflecting surface MX are received. Accordingly, the control unit CONT can efficiently measure the error information about the reflecting surface MX on the basis of the light-receiving result of the receiver.

After that, the final substrate of the previous lot on the substrate stage PST is exchanged with the head substrate of the next lot by the unillustrated substrate exchange mechanism at the substrate exchange position PST_{L}.

After the completion of the substrate exchange, the control unit CONT supplies the liquid LQ onto the substrate stage PST by controlling the liquid supply mechanism 10 and the liquid recovery mechanism 20 to form the liquid immersion area AR2 on the substrate stage PST. That is, the substrate stage PST is allowed to be in the wet state.

When the liquid immersion area is formed on the substrate stage PST, the control unit CONT moves the substrate stage PST in the +Y direction from the substrate exchange position PST_{L} to the intermediate position PST_{M} along the route opposite to that shown in FIG. 7 in the state (wet state) in which the liquid immersion area AR2 is formed on the substrate stage PST. The irregularity amount DX2(y) is calculated as the inclination data in the wet state of the reflecting surface MX of the movement mirror 42X in accordance with the same procedure as that described above by using only the data measured during the constant velocity movement included in the movement. The irregularity amount DX2(y) is stored in the memory MRY. In this procedure, the irregularity amount DX2(y) of the reflecting surface MX in the wet state of the movement mirror 42X is calculated on the basis of the following expression (7).
DX2(y)=−∫₀^{L′-y}θX(L′−y)dy+∫₀^{L′-y}Yθ(L′−y)dy (7)

Subsequently, the control unit CONT moves the substrate stage PST in the +X direction from the intermediate position PST_{M} to the exposure completion position PST_{E} along the route opposite to that shown in FIG. 6 in the state (wet state) in which the liquid immersion area AR2 is formed on the substrate stage PST. The irregularity amount DY2(x) is calculated as the inclination data in the wet state of the reflecting surface MY of the movement mirror 42Y in accordance with the same procedure as that described above by using only the data measured during the constant velocity movement included in the movement. The irregularity amount DY2(x) is stored in the memory MRY. In this procedure, the irregularity amount DY2(x) in the wet state of the reflecting surface MY of the movement mirror 42Y is calculated on the basis of the following expression (8).
DY2(x)=−∫₀^{L-x}θY(L−x)dx+∫₀^{L-x}Xθ(L−x)dx (8)

As described above, it is possible to efficiently measure the error information in the wet state and the error information in the dry state of the reflecting surfaces MX, MY during the period in which the substrate stage PST is moved in the directions of the predetermined axes, i.e., in the Y axis direction and the X axis direction substantially parallel to the reflecting surfaces MX, MY of the movement mirrors 42X, 42Y in the XY two-dimensional plane in order to exchange the substrate P. Further, the amount of local rotation (inclination) as the error of the reflecting surface and the amount of rotation (yawing) of the substrate stage PST are simultaneously measured during the period in which the substrate stage PST is moved in the directions of the predetermined axes, i.e., in the Y axis direction and the X axis direction substantially parallel to the reflecting surfaces MX, MY of the movement mirrors 42X, 42Y in the XY two-dimensional plane. The shape of the reflecting surface is calculated by using only the amount of local rotation of the reflecting surface of the movement mirror and the amount of rotation of the substrate stage PST corresponding thereto as measured when the substrate stage PST is moved at the substantially constant velocity. Further, there is such a possibility that any error of orthogonality arises, in which the substrate stage PST is moved while being deviated with respect to the X axis (or the Y axis), for example, due to any attachment error of at lease one of the movement mirrors MX, MY when the substrate stage PST, which has the reflecting surface MX and the reflecting surface MY substantially perpendicular to the reflecting surface MX, is moved in the X axis direction (or in the Y axis direction). However, according to the embodiment of the present invention, it is also possible to measure the information about the orthogonality error.

In the embodiment described above, the direction of movement of the substrate stage PST, which is used when the error information is measured in the dry state of the reflecting surfaces MX, MY described above, is opposite to the direction of movement of the substrate stage PST which is used when the error information is measured in the wet state. However, it is desirable that the respective pieces of error information about the reflecting surfaces are measured while moving the substrate stage PST in an identical direction in the respective states.

The following possibility arises in some situations when the irregularity amount is determined by adding up (integrating) the amount of partial warpage (angle of inclination) of the reflecting surface as described above. That is, when the data, which resides in the movement in only one direction, is used, then the errors, which are brought about when the approximation is made in accordance with the expressions (2) and (5) described above, may be added up, and a large error may be involved in the calculation result as the position approaches those disposed in the vicinity of the end of the reflecting surface. In such a circumstance, the following procedure may be also adopted. That is, the reciprocating movement in the X direction of the substrate stage PST and the reciprocating movement in the Y direction are performed in the dry state and the wet state respectively to average the irregularity amounts (inclination data) obtained along with the outward trip routes and the irregularity amounts (inclination data) obtained along with the return trip routes of the reflecting surfaces MX, MY of the movement mirrors 42X, 42Y so that the error has a value of an identical extent at any portion of the movement mirror. Accordingly, the measurement accuracy is improved for the surfaces shapes (irregularity amounts) of the reflecting surfaces MX, MY of the movement mirrors 42X, 42Y.

The explanation has been made such that the error information is measured for the reflecting surfaces MX, MY as described above every time when the substrate P is exchanged at every 1 lot. However, it is a matter of course that the measurement can be performed at any arbitrary timing. As for the method for measuring the error information about the reflecting surfaces MX, MY, it is also possible to use, for example, a method disclosed in Japanese Patent Application Laid-open No. 3-10105.

As described above, the error information about the reflecting surfaces MX, MY, which is obtained in the wet state in which the liquid LQ is supplied onto the substrate stage PST, is stored as the first information in the memory MRY. Further, the error information about the reflecting surfaces MX, MY, which is obtained in the dry state in which the liquid LQ is not supplied onto the substrate stage PST, is stored as the second information in the memory MRY.

The factor to cause the error (for example, the warpage, the inclination, and the irregularity) on the reflecting surface MX, MY of the movement mirror 42 is considered to include, for example, the production error of the movement mirror 42, the attachment error of the movement mirror 42 with respect to the substrate stage PST, and the deformation caused by the acceleration or deceleration movement of the substrate stage PST. In particular, in the case of the liquid immersion exposure apparatus, it is considered that the error arises on the reflecting surface MX, MY due to the pressure and the weight of the liquid LQ of the liquid immersion area AR2 formed on the substrate P and the substrate stage PST. In other words, the following possibility may arise. That is, the substrate stage PST is deformed merely slightly due to the pressure and the weight of the liquid LQ. The error (deformation) appears on the reflecting surface MX, MY of the movement mirror 42X, 42Y as a result of the deformation of the substrate stage PST. Therefore, a situation may possibly arise such that the error amount (for example, the warpage amount, the inclination amount, and the irregularity amount), which appears on the reflecting surface MX, MY of the movement mirror 42X, 42Y, mutually differs between the dry state and the wet state.

As for the liquid immersion exposure apparatus, the following arrangements are conceived when the measurement process is performed by using various types of measuring members provided on the substrate stage PST, including, for example, the reference member 300 and the optical sensors such as the uneven illuminance sensor 400 and the spatial image-measuring sensor 500 as described above. That is, in one arrangement, the measurement process is performed in the wet state in which the liquid immersion area AR2 of the liquid LQ is formed on the substrate stage PST (including the surface of the substrate P as well). In another arrangement, the measurement process is performed in the dry state in which the liquid immersion area AR2 is not formed on the substrate stage PST (including the surface of the substrate P as well). In such situations, if the error amount of the reflecting surface MX, MY of the movement mirror 42X, 42Y to serve as the measurement position reference mutually differs between the measurement in the dry state and the measurement in the wet state, then it is difficult to correlate the measurement result obtained in the dry state and the measurement result obtained in the wet state, and there is such a possibility that any inconvenience may arise to deteriorate the measurement accuracy. When the substrate P is subjected to the liquid immersion exposure (subjected to the exposure in the wet state) with reference to the measurement result obtained in the dry state, there is also such a possibility that the following inconvenience may arise. That is, it is impossible to accurately perform the wet exposure based on the use of the measurement result obtained in the dry state, depending on the difference in the error amount of the reflecting surface MX, MY between the dry state and the wet state.

Accordingly, in the embodiment of the present invention, the error information about the reflecting surface MX, MY in the wet state and the error information about the reflecting surface MX, MY in the dry state are previously determined, and the determined pieces of information are previously stored as the first information and the second information in the memory MRY. When the measurement process and the exposure process are performed, for example, the measurement result of the interferometer 43 and the position of the substrate stage PST are corrected on the basis of the error information stored in the memory MRY beforehand. Accordingly, it is possible to maintain the satisfactory measurement accuracy and the satisfactory exposure accuracy.

When the error information about the reflecting surface MX, MY is measured in order to obtain the first information and the second information, the measurement is performed in the state in which the substrate P is held on the substrate stage PST. There is such a possibility that the error amount of the reflecting surface MX, MY may mutually differ between the state in which the substrate P is held on the substrate stage PST and the state in which the substrate P is not held on the substrate stage PST, for example, due to the weight of the substrate P. On the other hand, the alignment process including the step of detecting the alignment mark 1 on the substrate P and the exposure process for performing the liquid immersion exposure for the substrate P are of course performed in the state in which the substrate P is held on the substrate stage PST. Therefore, when the substrate P is held on the substrate stage PST even when the error information about the reflecting surface MX, MY is measured, then it is possible to measure the error information about the reflecting surface MX, MY in conformity with the periods in which the alignment process and the exposure process are performed.

According to the embodiment of the present invention, the respective pieces of error information can be measured for the movement mirror 42X having the reflecting surface MX on the substrate stage PST and the movement mirror 42Y having the reflecting surface MY substantially perpendicular to the reflecting surface MX. Therefore, it is also possible to measure the information about the orthogonality error between the reflecting surface MX and the reflecting surface MY in the wet state and the dry state respectively.

When the error information about the reflecting surface MX, MY is measured, then the error information about the reflecting surface MX, MY may be measured in the dry state in which the liquid LQ is not supplied onto the substrate stage PST, and then the liquid LQ may be supplied onto the substrate stage PST to measure the error information about the reflecting surface MX, MY in the wet state in which the liquid LQ is supplied onto the substrate stage PST. Alternatively, the error information may be measured in the wet state, and then the error information may be measured in the dry state.

The measurement of the error information about the reflecting surface MX, MY is not limited to the procedure to be performed during the exchange operation between the final substrate included in the previous lot and the initial substrate included in the next lot. The error information may be obtained for the dry state and the wet state in relation to the reflecting surface MX, MY in a state in which the initial substrate of a certain lot is placed on the substrate stage PST. Alternatively, it is also allowable to distinctly provide a period of time in which the error information about the reflecting surface MX, MY is measured.

Next, an explanation will be made with reference to a flow chart shown in FIG. 9 about a method for exposing the substrate P with the pattern image of the mask M by using the exposure apparatus EX constructed as described above. This explanation will be made about the steps to be performed after the completion of the step (hereinafter appropriately referred to as “Step SA1”) of measuring the error information in the wet state of the reflecting surfaces MX, MY of the movement mirrors 42X, 42Y after importing the first substrate P of a certain lot onto the substrate stage PST as described above.

The memory MRY stores, as the first information, the error information about the reflecting surfaces MX, MY of the movement mirrors 42X, 42Y in the wet state in which the liquid LQ is supplied onto the substrate stage PST, and the memory MRY stores, as the second information, the error information about the reflecting surfaces MX, MY of the movement mirrors 42X, 42Y in the dry state in which the liquid LQ is not supplied onto the substrate stage PST, on the basis of the result of Step SA1 as described above.

Subsequently, various types of measurement processes are performed in order to accurately expose the substrate P (Step SA2).

At first, the control unit CONT supplies and recovers the liquid LQ by using the liquid supply mechanism 10 and the liquid recovery mechanism 20, for example, in the state in which the projection optical system PL is opposed to the upper plate 401 of the uneven illuminance sensor 400 to form the liquid immersion area of the liquid LQ between the upper surface 401A of the upper plate 401 and the optical element 2 disposed at the end portion of the projection optical system PL.

The control unit CONT radiates the exposure light beam EL from the illumination optical system IL in the wet state in which the liquid LQ is allowed to make contact with the optical element 2 of the projection optical system PL and the upper surface 401A of the upper plate 401 to detect the illuminance distribution of the exposure light beam EL in the projection area AR1 by means of the uneven illuminance sensor 400 via the projection optical system PL and the liquid LQ. Specifically, the substrate stage PST is moved so that the pinhole section 470 of the uneven illuminance sensor 400 is successively moved at a plurality of positions in the irradiation area (projection area) irradiated with the exposure light beam EL, in the state in which the liquid immersion area of the liquid LQ is formed on the upper surface 401A of the uneven illuminance sensor 400. The control unit CONT appropriately corrects the illuminance distribution of the exposure light beam EL so that the illuminance distribution of the exposure light beam is in a desired state in the projection area AR1 of the projection optical system PL on the basis of the detection result of the uneven illuminance sensor 400.

When the substrate stage PST is moved while measuring the position of the substrate stage PST by using the interferometer 43 during the measurement process of the uneven illuminance sensor 400 in the wet state via the liquid LQ, the control unit CONT controls the position of the substrate stage PST on the basis of the position information measured by the interferometer 43 and the first information stored in the memory MRY. Specifically, the control unit CONT determines the correction amount to correct the error amount of the reflecting surface MX, MY on the basis of the first information. The measurement result of the interferometer 43 is corrected on the basis of the correction amount. The position of the substrate stage PST is controlled by the aid of the substrate stage-driving unit PSTD on the basis of the corrected result. Alternatively, the driving amount, which is to be provided when the substrate stage PST is moved, may be corrected on the basis of the measurement result of the interferometer 43. As described above, the position (movement) of the substrate stage PST is controlled by compensating the error amount of the reflecting surface MX, MY. Therefore, the substrate stage PST is controlled in the same state as the state in which the reflecting surface MX, MY involves no error. Accordingly, it is possible to accurately measure the illuminance distribution of the exposure light beam EL.

After the detection of the illuminance distribution of the exposure light beam EL is completed, the control unit CONT uses the liquid recovery mechanism 20 to recover the liquid LQ of the liquid immersion area AR2 formed on the upper surface 401A of the upper plate 401 of the uneven illuminance sensor 400.

The measuring operation based on the use of the uneven illuminance sensor 400 has been explained above. However, the position of the substrate stage PST can be controlled on the basis of the first information previously stored in the memory MRY in the measuring process in the wet state through the liquid LQ by using the spatial image-measuring sensor 500 and the illuminance sensor as well. It is possible to accurately execute the respective measuring operations.

Subsequently, the measurement of the base line amount is performed as one of the measurement processes. The base line amount represents the positional relationship between the projection position of the pattern image and the detection reference position of the substrate alignment system 350 in the coordinate system defined by the laser interferometer. At first, the control unit CONT detects the reference mark MFM on the reference member 300 by means of the mask alignment system 360. When the reference mark MFM is detected, the control unit CONT moves the XY stage 53 so that the end portion of the projection optical system PL is opposed to the reference member 300. The control unit CONT supplies and recovers the liquid LQ by using the liquid supply mechanism 10 and the liquid recovery mechanism 20 to fill, with the liquid LQ, the space between the upper surface 301A of the reference member 300 and the optical element 2 disposed at the end portion of the projection optical system PL so that the liquid immersion area is formed.

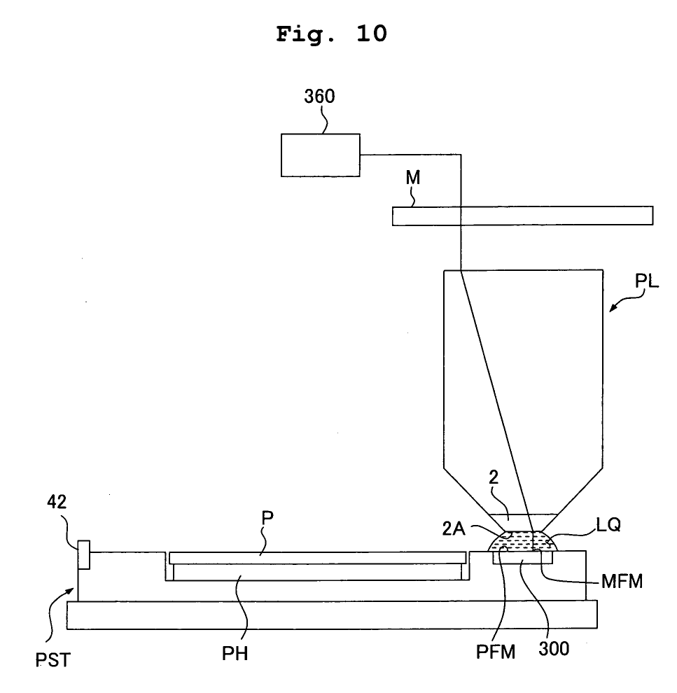

When the reference mark MFM on the reference member 300 is detected by using the mask alignment system 360, as shown in FIG. 10, the control unit CONT detects the reference mark MFM on the reference member 300 via the mask M, the projection optical system PL, and the liquid LQ (in the wet state) by using the mask alignment system 360, i.e., detects the positional relationship between the mark of the mask M and the reference mark MFM on the reference member 300. Accordingly, the information about the projection position of the pattern image of the mask M in the coordinate system defined by the laser interferometer 43 is detected by using the reference mark MFM.

When the mask alignment system 360 detects the reference mark MFM in the wet state, the control unit CONT measures the position of the substrate stage PST by using the laser interferometer 43. In this procedure, in the wet state in which the liquid LQ is supplied onto the substrate P, the control unit CONT controls the position of the substrate stage PST on the basis of the position information about the substrate stage PST measured by the interferometer 43 and the first information stored in the memory MRY. Specifically, the control unit CONT determines the correction amount to correct the error amount of the reflecting surface MX, MY on the basis of the first information. The measurement result of the interferometer 43 is corrected on the basis of the correction amount. The position of the substrate stage PST is controlled on the basis of the corrected result by the aid of the substrate stage-driving unit PSTD. Alternatively, the driving amount, which is to be provided when the substrate stage PST is moved, may be corrected on the basis of the measurement result of the interferometer 43. Also in this procedure, the position (movement) of the substrate stage PST is controlled by compensating the error amount of the reflecting surface MX, MY. Therefore, the projection position information about the pattern image of the mask M can be determined while controlling the substrate stage PST in the same state as the state in which the reflecting surface MX, MY involves no error.

After the detection of the reference mark MFM is completed, the control unit CONT recovers the liquid LQ of the liquid immersion area AR2 formed on the upper surface 301A of the reference member 300, by using the liquid recovery mechanism 20 or any predetermined liquid recovery mechanism provided distinctly from the liquid recovery mechanism 20. The liquid immersion area AR2 may be formed on the substrate stage PST as it is, or the liquid, which is disposed on the substrate stage PST, may be recovered by using the liquid recovery mechanism 20 every time when each of the measuring operations for measuring the error information about the reflecting surface MX, MY and the illuminance distribution by the uneven illuminance sensor 400 is completed, during the period from the start of the measurement of the error information in the wet state of the reflecting surface MX, MY until the completion of the detection of the reference mark MFM.

When the recovery of the liquid LQ is completed, the control unit CONT moves the XY stage 53 so that the detection area of the substrate alignment system 350 is positioned on the reference member 300.

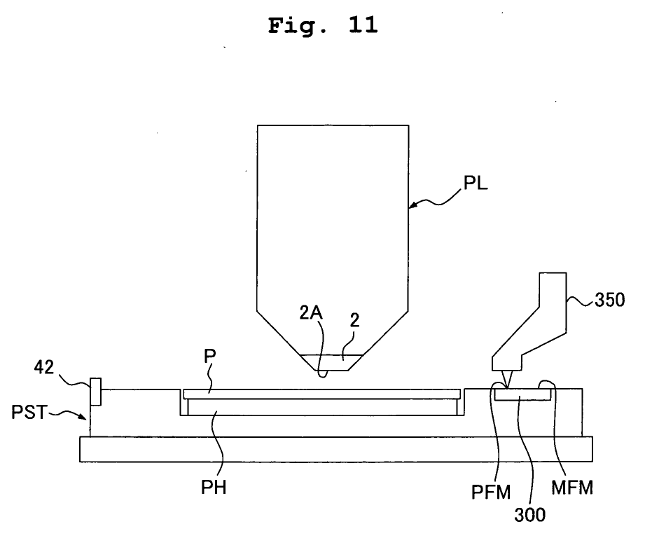

When the reference mark PFM on the reference member 300 is detected by the substrate alignment system 350, as shown in FIG. 11, the control unit CONT detects the reference mark PFM on the reference member 300 by using the substrate alignment system 350 without passing through the liquid LQ (in the dry state) to detect the position information about the reference mark PFM in the coordinate system defined by the laser interferometer 43. Accordingly, the detection reference position of the substrate alignment system 350 in the coordinate system defined by the laser interferometer 43 has been detected by using the reference mark PFM.

When the substrate alignment system 350 detects the reference mark PFM in the dry state, the control unit CONT measures the position of the substrate stage PST by using the laser interferometer 43. In this procedure, in the dry state in which the liquid LQ is not supplied onto the substrate P, the control unit CONT controls the position of the substrate stage PST on the basis of the position information about the substrate stage PST measured by the interferometer 43 and the second information stored in the memory MRY. Specifically, the control unit CONT determines the correction amount to correct the error amount of the reflecting surface MX, MY on the basis of the second information. The measurement result of the interferometer 43 is corrected on the basis of the correction amount. The position of the substrate stage PST is controlled on the basis of the corrected result by the aid of the substrate stage-driving unit PSTD. Alternatively, the driving amount, which is to be provided when the substrate stage PST is moved, may be corrected on the basis of the measurement result of the interferometer 43. As described above, the position (movement) of the substrate stage PST is controlled by compensating the error amount of the reflecting surface MX, MY. Therefore, the detection reference position of the substrate alignment system 350 can be determined while controlling the substrate stage PST in the same state as the state in which the reflecting surface MX, MY involves no error.

The control unit CONT determines the base line amount which resides in the spacing distance (positional relationship) between the detection reference position of the substrate alignment system 350 and the projection position of the image of the pattern. Specifically, the positional relationship (base line amount) between the detection reference position of the substrate alignment system 350 and the projection position of the pattern image in the coordinate system defined by the laser interferometer 43 is determined from the detection reference position of the substrate alignment system 350, the projection position of the pattern image, and the previously determined positional relationship between the reference mark PFM and the reference mark MFM.

As described above, the wet state and the dry state are present in a mixed manner when the base line amount is measured. However, when the position information about the substrate stage PST in the wet state and the position information about the substrate stage PST in the dry state are measured, the position of the substrate stage PST is controlled by correcting the error amount of the reflecting surface MX, MY of the movement mirror 42X, 42Y on the basis of the first information and the second information which have been previously determined. Therefore, the projection position of the pattern image of the mask M and the detection reference position of the substrate alignment system 350 are determined in approximately the same state as the state in which any error is absent on the reflecting surface MX, MY of the movement mirror 42X, 42Y. It is possible to accurately determine the base line amount.

Subsequently, the control unit CONT executes the alignment measurement process (Step SA3).

When the overlay exposure is performed for the substrate P, the control unit CONT detects the alignment marks 1 (FIG. 2) formed on the shot areas S1 to S24 as the exposure objective areas on the substrate P by using the substrate alignment system 350 without passing through the liquid LQ (in the dry state).

The position of the substrate stage PST, which is provided when the substrate alignment system 350 detects the alignment mark 1, is measured by the laser interferometer 43. The measurement result is outputted to the control unit CONT. When the substrate alignment system 350 detects the plurality of alignment marks 1 on the substrate P in the dry state, the control unit CONT also controls the position of the substrate stage PST on the basis of the position information measured by the interferometer 43 and the second information stored in the memory MRY. The control unit CONT determines the position information (deviation) of each of the shot areas S1 to S24 with respect to the detection reference position of the substrate alignment system 350 to determine, from the position of the substrate stage PST at that time, the alignment information (arrangement information) about the shot areas S1 to S24 in the coordinate system defined by the laser interferometer 43. As described above, the position of the substrate stage PST is controlled by using the second information stored in the memory MRY. Therefore, the alignment information (arrangement information) about the shot areas S1 to S24 can be determined in approximately the same state as the state in which the reflecting surface MX, MY involves no error. It is not necessarily indispensable that all of the alignment marks, which are formed in attendance on the shot areas S5 to S24, should be detected. It is also allowable that parts of the alignment marks are detected to determine the alignment information about the shot areas S1 to S24 as disclosed, for example, in Japanese Patent Application Laid-open No. 61-44492 (U.S. Pat. No. 4,780,617).

The focus-detecting system 30 (FIG. 1) can detect the surface position information about the surface of the substrate P without passing through the liquid LQ (in the dry state) concurrently with the detection of the alignment marks 1 on the substrate P by the substrate alignment system 350. The detection result of the focus-detecting system 30 is stored in the control unit CONT while corresponding to the position of the substrate P.

After the alignment marks 1 on the substrate P are detected by the substrate alignment system 350, the control unit CONT drives the liquid supply mechanism 10 to supply the liquid LQ onto the substrate P, and the control unit CONT drives the liquid recovery mechanism 20 to recover a predetermined amount of the liquid LQ disposed on the substrate P in order to perform the liquid immersion exposure for the substrate P. Accordingly, the liquid immersion area AR2 of the liquid LQ is formed between the substrate P and the optical element 2 disposed at the end portion of the projection optical system PL.

The control unit CONT projects the pattern image of the mask M onto the substrate P to perform the exposure (liquid immersion exposure) via the projection optical system PL and the liquid LQ disposed between the projection optical system PL and the substrate P while moving the substrate stage PST for supporting the substrate P in the X axis direction (scanning direction), while recovering the liquid LQ disposed on the substrate P by using the liquid recovery mechanism 20 concurrently with the supply of the liquid LQ onto the substrate P by using the liquid supply mechanism 10 (Step SA4).

The liquid LQ, which is supplied from the liquid supply section 11 of the liquid supply mechanism 10 in order to form the liquid immersion area AR2, flows through the supply tubes 13A, 13B, and then the liquid LQ is supplied onto the substrate P from the liquid supply ports 12A, 12B via the supply flow passages formed in the flow passage-forming member 70. The liquid LQ, which is supplied onto the substrate P from the liquid supply ports 12A, 12B, is supplied so that the liquid LQ is spread while causing the wetting between the substrate P and the lower end surface of the end portion (optical element 2) of the projection optical system PL. The liquid immersion area AR2, which is smaller than the substrate P and which is larger than the projection area AR1, is locally formed on a part of the substrate P including the projection area AR1. In this process, the control unit CONT simultaneously supplies the liquid LQ onto the substrate P from the both sides of the projection area AR1 in relation to the scanning direction from the liquid supply ports 12A, 12B arranged on the both sides in the X axis direction (scanning direction) of the projection area AR1, of the liquid supply mechanism 10 respectively. Accordingly, the liquid immersion area AR2 is formed uniformly and satisfactorily.

The exposure apparatus EX of the embodiment of the present invention performs the projection exposure for the substrate P with the pattern image of the mask M while moving the mask M and the substrate P in the X axis direction (scanning direction). During the scanning exposure, a part of the pattern image of the mask M is projected onto the portion included in the projection area AR1 via the projection optical system PL and the liquid LQ of the liquid immersion area AR2. The mask M is moved at the velocity V in the −X direction (or in the +X direction), in synchronization with which the substrate P is moved at the velocity β·V (β represents the projection magnification) in the +X direction (or in the −X direction) with respect to the projection area AR1. The plurality of shot areas S1 to S24 are established on the substrate P. After the exposure is completed for one shot area, the next shot area is moved to the scanning start position in accordance with the stepping movement of the substrate P. The scanning exposure process is successively performed thereafter for the respective shot areas S1 to S24 while moving the substrate P in accordance with the step-and-scan system.

When the plurality of shot areas S1 to S24 on the substrate P are successively subjected to the exposure respectively, the control unit CONT moves the XY stage 53 on the basis of the base line amount determined in Step SA2 and the position information (arrangement information) of the respective shot areas S1 to S24 determined in Step SA3 to perform the liquid immersion exposure process for the respective shot areas S1 to S24 while performing the positional adjustment for the pattern image and the respective shot areas S1 to S24 on the substrate P.

The control unit CONT measures the position of the substrate stage PST by using the laser interferometer 43 when the liquid immersion scanning exposure is performed for each of the shot areas on the substrate P in the wet state as well. In this procedure, in the wet state in which the liquid LQ is supplied onto the substrate P, the control unit CONT controls the position of the substrate stage PST on the basis of the position information about the substrate stage PST measured by the interferometer 43 and the first information stored in the memory MRY. Specifically, in the same manner as described above, the control unit CONT determines the correction amount in order to correct the error amount of the reflecting surface MX, MY on the basis of the first information. The measurement result of the interferometer 43 is corrected on the basis of the correction amount. The position of the substrate stage PST is controlled on the basis of the corrected result by the aid of the substrate stage-driving unit PSTD. Alternatively, the driving amount, which is to be provided when the substrate stage PST is moved, may be corrected on the basis of the measurement result of the interferometer 43 in the same manner as described above. As described above, the position (movement) of the substrate stage PST is controlled by compensating the error amount of the reflecting surface MX, MY by using the first information stored in the memory MRY. Therefore, the position (movement) of the substrate stage PST can be accurately controlled in approximately the same state as the state in which the reflecting surface MX, MY involves no error. The positional adjustment can be correctly performed for the pattern image of the mask M and the respective shot areas on the basis of the position information (arrangement information) about the respective shot areas S1 to S24 measured in the state in which the liquid is absent on the substrate stage PST.

In the embodiment described above, the position of the substrate stage PST is controlled in approximately the same state as the state in which the reflecting surface MX, MY involves no error in the dry state as well as in the wet state on the basis of the error information in relation to the reflecting surface MX, MY. However, there is no limitation thereto. The position of the substrate stage PST may be controlled in a common predetermined state in relation to the reflecting surface MX, MY in the dry state as well as in the wet state.

The control unit CONT detects the surface position information about the surface of the substrate P by using the focus-detecting system 30, and the liquid immersion exposure process is performed for the respective shot areas S1 to S24 while changing the image characteristic of the projection optical system PL, and/or moving the substrate P in the Z axis direction or in any direction of inclination by the aid of the substrate stage PST so that the surface of the substrate P is adjusted and matched with respect to the image plane formed via the projection optical system PL and the liquid LQ. The focus-detecting system 30 detects the surface position information about the surface of the substrate P such that the detecting light beam La is radiated from the light-emitting section 30A through the liquid LQ onto the substrate P, and the reflected light beam from the substrate P is received by the light-receiving section 30B.

The positional relationship between the surface of the substrate P and the image plane formed through the liquid LQ may be adjusted without using the focus-detecting system 30 on the basis of the surface information about the substrate P determined before the supply of the liquid LQ, during the scanning exposure for each of the shot areas S1 to S24. Alternatively, the position of the surface of the substrate P may be controlled while considering both of the surface position information about the substrate P determined before the supply of the liquid LQ and the surface position information about the substrate P detected through the liquid LQ during the scanning exposure.

After the completion of the liquid immersion exposure for the respective shot areas S1 to S24 on the substrate P, the control unit CONT recovers the liquid LQ of the liquid immersion area AR2 formed on the substrate P by using the liquid recovery mechanism 20 (Step SA5).

In this procedure, the liquid recovery mechanism 20 also recovers the liquid LQ remaining on the upper surface of the substrate stage PST in addition to the recovery of the liquid LQ disposed on the substrate P.

After the liquid LQ disposed on the substrate P and the substrate stage PST is recovered, the control unit CONT exports (unloads) the exposed substrate P from the substrate stage PST (Step SA6).

When the second substrate P′ or any one of the followings is held on the substrate stage PST to perform the exposure after the completion of the exposure for the first substrate P, the positional adjustment can be performed between the projection position of the pattern image of the mask M and the shot areas S1 to S24 of the substrate P′ without performing, for example, the measurement of the error information about the reflecting surface MX, MY in Step SA1, the detection of the position information about the reference mark PFM, MFM on the substrate stage PST in Step SA2, and the measurement of the illuminance distribution with the uneven illuminance sensor 400. In this procedure, the another substrate P′ is held on the substrate stage PST, and then the process is advanced to Step SA3 while omitting Steps SA1, SA2 so that the position information about the alignment marks 1 provided in attendance on the shot areas S1 to S24 is detected by using the substrate alignment system 350. Accordingly, the position information about the respective shot areas S1 to S24 is determined with respect to the detection reference position of the substrate alignment system 350 in the same manner as for the first substrate P having been exposed previously. Accordingly, the positional adjustment is effected between the pattern image and the respective shot areas S1 to S24 on the substrate P′, and the respective shot areas of the substrate P′ can be exposed with the pattern image.

The operation for detecting the reference mark PFM, MFM to determine the base line amount may be performed every predetermined intervals, for example, every time when a preset number of sheets of the substrates are processed or every time when the mask is exchanged.

As described above, the error information about the reflecting surface MX, MY, which is obtained in the state of the supply of the liquid LQ onto the substrate stage PST, is previously measured and stored in the memory MRY. Accordingly, when the position information about the substrate stage PST to which the liquid LQ is supplied is measured by using the interferometer 43, then the measured position information about the substrate stage PST can be corrected and/or the position of the substrate stage PST can be controlled on the basis of the error information stored in the memory MRY. Therefore, the position of the substrate stage PST can be controlled satisfactorily, and thus it is possible to perform the exposure process accurately for the substrate P held by the substrate stage PST.

The force, which is exerted by the liquid LQ on the substrate P (substrate stage PST), is changed depending on the material characteristic of the substrate surface as the liquid contact surface (including the upper surface of the substrate stage PST). Specifically, the force, which is exerted by the liquid LQ on the substrate P, is changed depending on the affinity between the surface of the substrate P and the liquid LQ, and more specifically on the contact angle of the substrate P with respect to the liquid LQ. The material characteristic of the surface of the substrate P is changed depending on the photosensitive material with which the surface of the substrate P is coated and the predetermined film with which the photosensitive material is coated, including, for example, the protective film for protecting the photosensitive material. For example, when the surface of the substrate P is liquid-attractive, the liquid LQ intends to spread while causing the wetting on the substrate P. Therefore, the pressure of the liquid LQ on the substrate P is lowered (negative pressure is provided). On the other hand, when the surface of the substrate P is liquid-repellent, the pressure of the liquid LQ on the substrate P is raised (positive pressure is provided). As described above, the force, which is exerted by the liquid LQ on the substrate P, is changed depending on the contact angle (affinity) of the surface of the substrate P with respect to the liquid LQ. Therefore, if the contact angle with respect to the liquid LQ, which is possessed by the surface of the substrate held on the substrate stage PST when the error information about the reflecting surface MX, MY is measured, is different from the contact angle with respect to the liquid LQ which is possessed by the surface of the substrate P as the exposure objective actually subjected to the exposure process, the error amount, which arises on the reflecting surface MX, MY upon the measurement of the error in the wet state, is mutually different from the error amount which arises on the reflecting surface MX, MY upon the exposure process in the wet state. In such a situation, it is impossible to satisfactorily perform the control of the position (correction of the position) of the substrate stage PST by using the previously measured error information.

Therefore, it is desirable that the contact angle with respect to the liquid LQ, which is possessed by the surface of the substrate P held on the substrate stage PST when the error information about the reflecting surface MX, MY is measured, is approximately the same as the contact angle with respect to the liquid LQ which is possessed by the surface of the substrate P as the exposure objective for being irradiated with the exposure light beam EL. Accordingly, it is possible to satisfactorily perform the control of the position (correction of the position) of the substrate stage PST by using the previously measured error information about the reflecting mirror MX, MY.

In the embodiment described above, the error information about the reflecting surface MX, MY is measured after the substrate P to be exposed next is held on the substrate stage PST. However, the error information about the reflecting surface MX, MY may be measured such that a dummy substrate, which has approximately the same contact angle with respect to the liquid LQ as that of the surface of the substrate P to be actually exposed, is placed on the substrate stage PST.

When the contact angle with respect to the liquid LQ, which is possessed by the surface of the substrate (surface of the dummy substrate) held on the substrate stage PST when the error information about the reflecting surface MX, MY is measured, is different from the contact angle with respect to the liquid LQ which is possessed by the surface of the substrate P as the exposure objective for being irradiated with the exposure light beam EL, the relationship between the information about the contact angle of the substrate surface with respect to the liquid LQ and the information about the liquid pressure corresponding thereto (as well as the error information about the reflecting surface MX, MY) is previously measured and stored in the memory MRY. Accordingly, it is possible to satisfactorily perform the control of the position (correction of the position) of the substrate stage PST during the alignment process and the exposure process in the wet state on the basis of the relationship.

The factor to change the pressure of the liquid LQ on the substrate stage PST includes, for example, the contact angle of the substrate surface (including the upper surface of the substrate stage) with respect to the liquid LQ as described above, as well as the movement velocity of the substrate stage PST, the weight of the liquid LQ, the supply amount of the liquid LQ per unit time, and the recovery amount of the liquid LQ per unit time. Accordingly, when the error information about the reflecting surface MX, MY is measured, it is preferable to set the measuring condition taking the factor as described above into consideration.

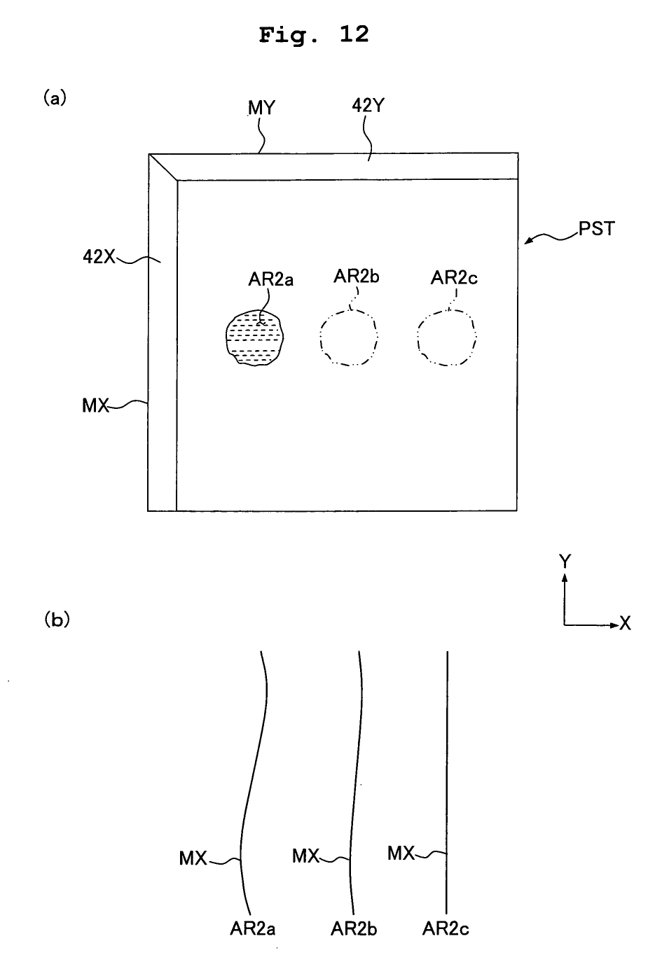

The position of the liquid immersion area AR2 on the substrate stage PST, which is formed on the image plane side of the projection optical system PL, is changed depending on the movement of the substrate stage PST. On the other hand, there is such a possibility that the error amount of the reflecting surface MX, MY may be varied depending on the position of the liquid immersion area AR2 of the liquid LQ on the substrate stage PST. For example, the following possibility arises. That is, when the position of the liquid immersion area of the liquid LQ is changed in relation to the X axis direction as indicated by symbols AR2a, AR2b, AR2c as shown in FIG. 12(a), for example, the error (for example, the warpage, the inclination, and the irregularity) of the reflecting surface MX is changed corresponding to the position of the liquid immersion area AR2 as shown in FIG. 12(b). Similarly, the following possibility arises. That is, the error (for example, the warpage, the inclination, and the irregularity) of the reflecting surface MY is also changed depending on the position of the liquid immersion area AR2 on the substrate stage PST.

Accordingly, when the error information about the reflecting surface MX, MY in the wet state is measured, then the position of the substrate stage PST is varied, and a plurality of pieces of information, which correspond to the positions of the liquid immersion area AR2 of the liquid LQ on the substrate stage PST, are measured a plurality of times. The plurality of pieces of information, which correspond to the positions of the liquid immersion area AR2, are stored as the first information in the memory MRY. Accordingly, the driving amount of the substrate stage PST is corrected and/or the measurement result of the interferometer 43 is corrected corresponding to the position of the liquid immersion area AR2 on the substrate stage PST during the exposure process and/or the alignment process (measurement process). Thus, it is possible to control the position of the substrate stage PST more accurately.

For example, the substrate stage PST is moved in the X axis direction (or in the Y axis direction) in the state in which the liquid immersion area AR2 is formed on the substrate stage PST to measure a plurality of pieces of error information about the reflecting surface MX, MY corresponding to a plurality of positions of the substrate stage PST in relation to the X axis direction (Y axis direction) respectively. For example, a predetermined calculation processing, for example, an interpolation processing is applied to the plurality of pieces of error information measured two-dimensionally respectively. Accordingly, the position of the substrate stage PST can be controlled extremely highly accurately over the entire movement range of the substrate stage PST based on the use of the movement mirror 42X, 42Y.

In the embodiment described above, the position of the substrate stage PST is controlled on the basis of the error information about the reflecting surface MX, MY of the movement mirror. However, for example, when the positional adjustment is performed for the mask M and the substrate P, the position of the mask stage MST may be controlled on the basis of the error information.

The present invention is also applicable to a twin-stage type exposure apparatus. The structure and the exposure operation of the twin-stage type exposure apparatus are disclosed, for example, in Japanese Patent Application Laid-open Nos. 10-163099 and 10-214783 (corresponding to U.S. Pat. Nos. 6,341,007, 6,400,441, 6,549,269, and 6,590,634), Japanese Patent Application Laid-open No. 2000-505958 (PCT) (corresponding to U.S. Pat. No. 5,969,441), and U.S. Pat. No. 6,208,407. The disclosures thereof are incorporated herein by reference within a range of permission of the domestic laws and ordinances of the state designated or selected in this international application.

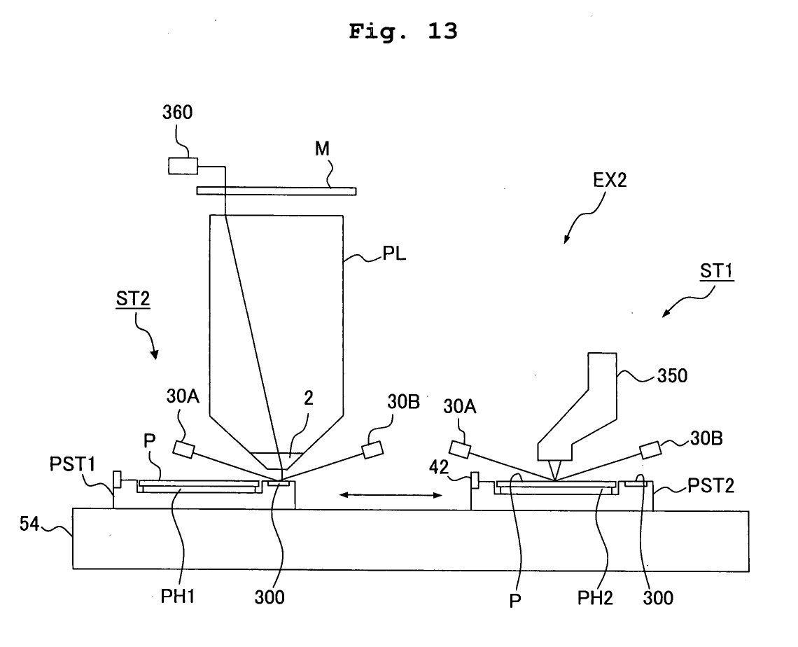

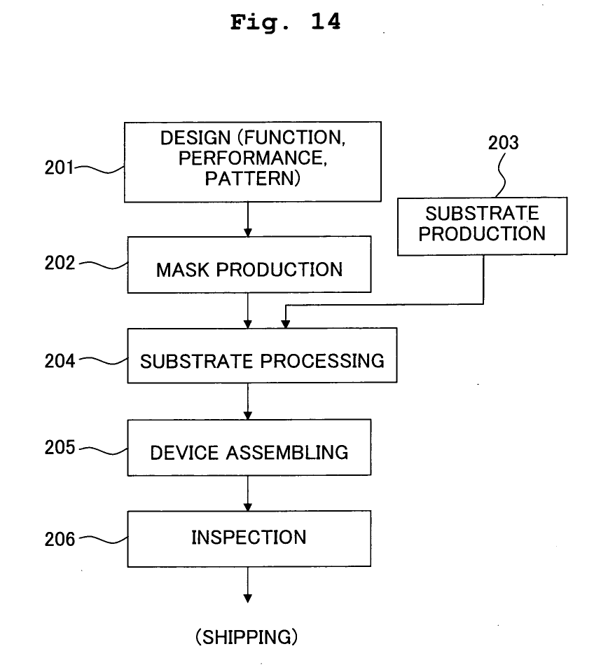

FIG. 13 shows a schematic arrangement illustrating an example of the twin-stage type exposure apparatus. The twin-stage type exposure apparatus EX2 shown in FIG. 13 comprises a first substrate stage PST1 which has a substrate holder PH1 for holding the substrate P and which is movable while holding the substrate P on the substrate holder PH1, and a second substrate stage PST2 which has a substrate holder PH2 for holding the substrate P and which is movable while holding the substrate P on the substrate holder PH2. The first and second substrate stages PST1, PST2 are movable independently respectively on a common base 54. Each of the first and second substrate stages PST1, PST2 is provided with the reference member 300 and the sensors including, for example, the uneven illuminance sensor 400 and the spatial image-measuring sensor 500 in the same manner as in the embodiment described above.

The twin-stage type exposure apparatus EX2 further comprises a measuring station ST1 for performing the measurement for the substrate P held by one substrate stage PST1 (PST2), and an exposure station ST2 for performing the exposure for the substrate P held by the other substrate stage PST2 (PST1). All of the components of the system shown in FIG. 1 (including the focus-detecting system 300) except for the substrate alignment system 350 are carried on the exposure station ST2. The substrate alignment system 350 and the focus-detecting system 30 provided with the light-emitting section 30A and the light-receiving section 30B are carried on the measuring station ST1.

The basic operation of the twin-stage type exposure apparatus as described above is performed as follows. That is, for example, the exposure process is performed for the substrate P disposed on the second substrate stage PST2 in the exposure station ST2, during which the exchange process and the measurement process are performed for the substrate P disposed on the first substrate stage PST1 in the measuring station ST1. When the respective operations are completed, the second substrate stage PST2 is moved to the measuring station ST1, concurrently with which the first substrate stage PST1 is moved to the exposure station ST2. In this situation, the measurement process and the exchange process are performed on the second substrate stage PST2, and the exposure process is performed for the substrate P disposed on the first substrate stage PST1.

In this embodiment, the measurement of the substrate P in the measuring station ST1 includes the measurement of the surface position information about the surface of the substrate P to be performed by the focus-detecting system 30, and the detection of the alignment marks 1 on the substrate P and the reference mark PFM on the reference member 300 to be performed by the substrate alignment system 350. For example, the liquid immersion exposure process is performed in the exposure station ST2 for the substrate P disposed on the second substrate stage PST2, during which the measurement process is performed by using the substrate alignment system 350, the focus-detecting system 30, and the reference member 300 in the measuring station ST1 for the substrate P disposed on the first substrate stage PST1. When the measurement process is completed, the exchange operation is performed for the first substrate stage PST1 and the second substrate stage PST2. As shown in FIG. 13, the first substrate stage PST1 is positioned so that the reference member 300 on the first substrate stage PST1 is opposed to the projection optical system PL. In this state, the control unit CONT starts the supply of the liquid LQ to fill, with the liquid LQ, the space between the projection optical system PL and the reference member 300. The positional relationship between the mask M and the reference mark on the substrate stage PST1 is detected by the mask alignment system 360 through the liquid LQ, and the exposure process is performed. The alignment information about the respective shot areas S1 to S24 having been already determined in the measuring station ST1 is established (stored) on the basis of the reference mark PFM of the reference member 300. When the liquid immersion exposure is executed in the exposure station ST2, the movement of the first substrate stage PST1 is controlled so that the respective shot areas S1 to S24 are positioned on the basis of the positional relationship between the mask M and the reference mark MFM formed in the predetermined positional relationship with respect to the reference mark PFM of the reference member 300. That is, the alignment information about the respective shot areas S1 to S24 determined in the measuring station ST1 is effectively transferred to the exposure station ST2 by using the reference marks PFM, MFM.

As described above, in the case of the twin-stage type exposure apparatus, the liquid immersion exposure process can be performed on one stage, during which the measurement process can be performed on the other stage without passing through the liquid. Therefore, it is possible to improve the throughput of the exposure process.

Also in the case of the twin-stage type exposure apparatus EX2, the respective pieces of error information about the reflecting surface MX, MY of the movement mirror 42X, 42Y in the wet state and the dry state are previously determined for each of the stages, and the obtained results are stored in the memory MRY beforehand. Accordingly, it is possible to highly accurately perform the control of the position of the substrate stage PST1 (PST2) in each of the stations. That is, in relation to the exposure station ST2, the position of the substrate stage PST1 (PST2) can be controlled on the basis of the position information measured by the interferometer 43 and the first information stored in the memory MRY in the wet state in which the liquid LQ is supplied onto the substrate stage PST1 (PST2), while the position of the substrate stage PST1 (PST2) can be controlled on the basis of the position information measured by the interferometer 43 and the second information stored in the memory MRY in the dry state in which the liquid LQ is not supplied onto the substrate stage PST1 (PST2). For example, the position of the substrate stage PST1 (PST2) can be controlled in approximately the same state as the state in which any error of the reflecting surface is absent in any one of the stations. Therefore, the substrate P disposed on the substrate stage PST1 (PST2), which is subjected to the position control in the wet state in the exposure station ST2, can be accurately exposed by using various pieces of information (for example, the alignment information and the focus information) measured while moving the substrate stage PST1 (PST2) in the dry state in the measuring station ST1.

The present invention is not limited to the twin-stage type exposure apparatus provided with the two stages for holding the substrate P. The present invention is also applicable to an exposure apparatus provided with a stage which holds the substrate P and a measuring stage which carries measuring members and sensors, as disclosed in Japanese Patent Application Laid-open No. 2000-164504. In this case, when a reflecting surface for an interferometer is formed on the measuring stage, it is desirable that the error information about the reflecting surface of the measuring stage is also measured in the same manner as the substrate stage.

In the embodiment described above, the description has been made about the error information about the reflecting surface MX, MY to measure the position information in the X direction and the Y direction of the substrate stage PST. However, the present invention is also applicable to a reflecting surface for measuring the position in the Z direction of the substrate stage PST as disclosed in Japanese Patent Application Laid-open Nos. 2001-510577 and 2001-513267 (PCT) and Japanese Patent Application Laid-open No. 2000-323404.

In the embodiment described above, the error information in the dry state and the error information in the wet state of the reflecting surface MX, MY of the reflecting mirror are held, and the position of the substrate stage PST is controlled on the basis of the information. However, there is no limitation to the error information about the reflecting surface of the movement mirror. It is desirable that various pieces of control information about the substrate stage PST are held in the memory MRY while corresponding to the dry state and the wet state respectively. For example, as disclosed in Japanese Patent Application Laid-open No. 10-70065, pieces of displacement information about the displacement in the Z direction of the substrate stage PST caused, for example, by the deformation of the base 54 may be held while corresponding to the dry state and the wet state respectively. Accordingly, it is possible to accurately control the position of the substrate stage PST in the dry state and the wet state respectively. Additionally, even when the dry state and the wet state are present in a mixed manner, it is possible to highly accurately perform the measurement process and the exposure process.

As disclosed in Japanese Patent Application Laid-open No. 2-153519, when any positional deviation arises in the XY plane when the Z stage 52 is subjected to the tilting, then pieces of information about the positional deviation may be held in the memory MRY while corresponding to the dry state and the wet state respectively. Accordingly, for example, the substrate P and various measuring members disposed on the Z stage can be accurately subjected to the position control in both of the dry state and the wet state. In other situations, when the substrate stage and various measuring members disposed on the substrate stage, which are in the wet state, undergo the displacement different from that in the dry state, due to the change of the environment including, for example, the pressure, the humidity, and the temperature, caused by the supply of the liquid to the substrate or the substrate stage, then the displacements as described above can be measured in the dry state and the wet state respectively, and the obtained results can be stored in the memory MRY.

As described above, in the embodiment of the present invention, pure water is used as the liquid LQ. Pure water is advantageous in that pure water is available in a large amount with ease, for example, in the semiconductor production factory, and pure water exerts no harmful influence, for example, on the optical element (lens) and the photoresist on the substrate P. Further, pure water exerts no harmful influence on the environment, and the content of impurity is extremely low. Therefore, it is also expected to obtain the function to wash the surface of the substrate P and the surface of the optical element provided at the end surface of the projection optical system PL. When the purity of pure water supplied from the factory or the like is low, it is also appropriate that the exposure apparatus is provided with an ultrapure water-producing unit.

It is approved that the refractive index n of pure water (water) with respect to the exposure light beam EL having a wavelength of about 193 nm is approximately in an extent of 1.44. When the ArF excimer laser beam (wavelength: 193 nm) is used as the light source of the exposure light beam EL, then the wavelength is shortened on the substrate P by 1/n, i.e., to about 134 nm, and a high resolution is obtained. Further, the depth of focus is magnified about n times, i.e., about 1.44 times as compared with the value obtained in the air. Therefore, when it is enough to secure an approximately equivalent depth of focus as compared with the case of the use in the air, it is possible to further increase the numerical aperture of the projection optical system PL. Also in this viewpoint, the resolution is improved.

When the liquid immersion method is used as described above, the numerical aperture NA of the projection optical system is 0.9 to 1.3 in some cases. When the numerical aperture NA of the projection optical system is increased as described above, the image formation performance is sometimes deteriorated by the polarization effect with the random polarized light beam having been hitherto used as the exposure light beam. Therefore, it is desirable to use the polarized illumination. In this case, the following procedure is preferred. That is, the linear polarized illumination is effected, which is adjusted to the longitudinal direction of the line pattern of the line-and-space pattern of the mask (reticle) so that a large amount of diffracted light of the S-polarized component (TE-polarized component), i.e., the component in the polarization direction along the longitudinal direction of the line pattern is allowed to outgo from the pattern of the mask (reticle). When the space between the projection optical system PL and the resist coated on the surface of the substrate P is filled with the liquid, the diffracted light of the S-polarized component (TE-polarized component), which contributes to the improvement in the contrast, has the transmittance through the resist surface that is raised to be high as compared with a case in which the space between the projection optical system PL and the resist coated on the surface of the substrate P is filled with the air (gas). Therefore, even when the numerical aperture NA of the projection optical system exceeds 1.0, it is possible to obtain the high image formation performance. It is more effective to make appropriate combination, for example, with the phase shift mask and/or the oblique incidence illumination method (especially the dipole illumination method) adjusted to the longitudinal direction of the line pattern as disclosed in Japanese Patent Application Laid-open No. 6-188169.

Further, for example, when the ArF excimer laser beam is used as the exposure light beam, and the substrate P is exposed with a fine line-and-space pattern (for example, line-and-space of about 25 to 50 nm) by using the projection optical system PL having a reduction magnification of about ¼, then the mask M functions as a polarizing plate on account of the Wave Guide effect depending on the structure of the mask M (for example, the pattern fineness and the chromium thickness), and a large amount of the diffracted light beam of the S-polarized component (TE-polarized component) is radiated from the mask M as compared with the diffracted light beam of the P-polarized component (TM-component) which lowers the contrast. In such a situation, it is desirable that the linear polarized illumination is used as described above. However, the high resolution performance can be obtained even when the numerical aperture NA of the projection optical system PL is large, for example, 0.9 to 1.3 even when the mask M is illuminated with the random polarized light beam. When the substrate P is exposed with an extremely fine line-and-space pattern on the mask M, there is also such a possibility that the P-polarized component (TM-polarized component) may be larger than the S-polarized component (TE-polarized component) on account of the Wire Grid effect. However, for example, when the ArF excimer laser beam is used as the exposure light beam, and the substrate P is exposed with a line-and-space pattern larger than 25 nm by using the projection optical system PL having a reduction magnification of about ¼, then a large amount of the diffracted light beam of the S-polarized component (TE-polarized component) is radiated from the mask M as compared with the diffracted light beam of the P-polarized component (TM-polarized component). Therefore, the high resolution performance can be obtained even when the numerical aperture NA of the projection optical system PL is large, for example, 0.9 to 1.3.

Further, it is also effective to use a combination of the oblique incidence illumination method and the polarized illumination method in which the linear polarization is effected in a tangential (circumferential) direction of a circle having a center of the optical axis as disclosed in Japanese Patent Application Laid-open No. 6-53120 as well as the linear polarized illumination (S-polarized illumination) adjusted to the longitudinal direction of the line pattern of the mask (reticle). In particular, when the pattern of the mask (reticle) includes not only the line pattern which extends in a predetermined one direction but the pattern also includes line patterns which extend in a plurality of directions in a mixed manner, then the high image formation performance can be obtained even when the numerical aperture NA of the projection optical system is large, by using, in combination, the zonal (annular) illumination method and the polarized illumination method in which the linear polarization is effected in a tangential direction of a circle having a center of the optical axis as disclosed in Japanese Patent Application Laid-open No. 6-53120 as well.

In the embodiment of the present invention, the optical element 2 is attached to the end portion of the projection optical system PL. The lens can be used to adjust the optical characteristics of the projection optical system PL, including, for example, the aberration (for example, spherical aberration and comatic aberration). The optical element, which is attached to the end portion of the projection optical system PL, may be an optical plate to be used to adjust the optical characteristic of the projection optical system PL. Alternatively, the optical element may be a plane parallel plate through which the exposure light beam EL is transmissive. When the optical element to make contact with the liquid LQ is the plane parallel plate which is cheaper than the lens, it is enough that the plane parallel plate is merely exchanged immediately before supplying the liquid LQ even when any substance (for example, any silicon-based organic matter), which deteriorates the transmittance of the projection optical system PL, the illuminance of the exposure light beam EL on the substrate P, and the uniformity of the illuminance distribution, is adhered to the plane parallel plate, for example, during the transport, the assembling, and/or the adjustment of the exposure apparatus EX. An advantage is obtained such that the exchange cost is lowered as compared with the case in which the optical element to make contact with the liquid LQ is the lens. That is, the surface of the optical element to make contact with the liquid LQ is dirtied, for example, due to the adhesion of scattered particles generated from the resist by being irradiated with the exposure light beam EL or any impurity contained in the liquid LQ. Therefore, it is necessary to periodically exchange the optical element. However, when the optical element is the cheap plane parallel plate, then the cost of the exchange part is low as compared with the lens, and it is possible to shorten the time required for the exchange. Thus, it is possible to suppress the increase in the maintenance cost (running cost) and the decrease in the throughput.

When the pressure, which is generated by the flow of the liquid LQ, is large between the substrate P and the optical element disposed at the end portion of the projection optical system PL, it is also allowable that the optical element is tightly fixed so that the optical element is not moved by the pressure, without allowing the optical element to be exchangeable.

The embodiment of the present invention is constructed such that the space between the projection optical system PL and the surface of the substrate P is filled with the liquid LQ. However, for example, another arrangement may be adopted such that the space is filled with the liquid LQ in a state in which a cover glass composed of a plane parallel plate is attached to the surface of the substrate P.

The exposure apparatus, to which the liquid immersion method is applied as described above, is constructed such that the optical path space, which is disposed on the light-outgoing side of the terminal end optical element 2 of the projection optical system PL, is filled with the liquid (pure water) to expose the substrate P. However, as disclosed in International Publication No. 2004/019128, it is also allowable that the optical path space, which is disposed on the light-incoming side of the terminal end optical element 2 of the projection optical system PL, is filled with the liquid (pure water). In this arrangement, it is also allowable that the pressure of the liquid is adjusted in the optical path space disposed on the light-incoming side of the terminal end optical element 2 of the projection optical system PL. Further, when the supply of the liquid is started while discharging the gas disposed in the optical path space on the light-incoming side of the terminal end optical element 2 of the projection optical system PL, the optical path space can be filled with the liquid quickly and satisfactorily.

The liquid LQ is water in the embodiment of the present invention. However, the liquid LQ may be any liquid other than water. For example, when the light source of the exposure light beam EL is the F₂ laser, the F₂ laser beam is not transmitted through water. Therefore, in this case, those preferably usable as the liquid LQ may include, for example, a fluorine-based fluid such as fluorine-based oil and perfluoropolyether (PFPE) through which the F₂ laser beam is transmissive. In this case, the portion to make contact with the liquid LQ is subjected to the liquid-attracting treatment by forming a thin film, for example, with a substance having a molecular structure of small polarity including fluorine. Alternatively, other than the above, it is also possible to use, as the liquid LQ, those (for example, cedar oil) which have the transmittance with respect to the exposure light beam EL, which have the refractive index as high as possible, and which are stable against the photoresist coated on the surface of the substrate P and the projection optical system PL. Also in this case, the surface treatment is performed depending on the polarity of the liquid LQ to be used. It is also possible to use various fluids having desired refractive indexes, for example, any supercritical fluid or any gas having a high refractive index, in place of pure water for the liquid LQ.

The substrate P, which is usable in the respective embodiments described above, is not limited to the semiconductor wafer for producing the semiconductor device. Those applicable include, for example, the glass substrate for the display device, the ceramic wafer for the thin film magnetic head, and the master plate (synthetic quartz, silicon wafer) for the mask or the reticle to be used for the exposure apparatus.

As for the exposure apparatus EX, the present invention is also applicable to the scanning type exposure apparatus (scanning stepper) based on the step-and-scan system for performing the scanning exposure with the pattern of the mask M by synchronously moving the mask M and the substrate P as well as the projection exposure apparatus (stepper) based on the step-and-repeat system for performing the full field exposure with the pattern of the mask M in a state in which the mask M and the substrate P are allowed to stand still, while successively step-moving the substrate P. The present invention is also applicable to the exposure apparatus based on the step-and-stitch system in which at least two patterns are partially overlaid and transferred on the substrate P. The present invention is also applicable to the full field exposure apparatus based on the stitch system wherein the substrate P is subjected to the full field exposure with a reduction image of a first pattern in a state in which the first pattern and the substrate P are allowed to substantially stand still by using a projection optical system (for example, a dioptric type projection optical system having a reduction magnification of ⅛ and including no catoptric element), and then the substrate P is subjected to the full field exposure with a reduction image of a second pattern while being partially overlaid with the first pattern in a state in which the second pattern and the substrate P are allowed to substantially stand still by using the projection optical system.

The embodiment described above adopts the exposure apparatus in which the space between the projection optical system PL and the substrate P is locally filled with the liquid. However, the present invention is also applicable to a liquid immersion exposure apparatus in which the entire surface of the substrate as the exposure objective is covered with the liquid. The structure and the exposure operation of the liquid immersion exposure apparatus in which the entire surface of the substrate as the exposure objective is covered with the liquid are described in detail, for example, in Japanese Patent Application Laid-open Nos. 6-124873 and 10-303114 and U.S. Pat. No. 5,825,043. The contents of the descriptions in these literatures are incorporated herein by reference within a range of permission of the domestic laws and ordinances of the state designated or selected in this international application.

Various types of projection optical systems can be also used as the projection optical system carried on the exposure apparatus. For example, it is also possible to use a projection optical system of the catadioptric type including catoptric and dioptric elements. It is also possible to use a projection optical system of the catoptric type including only a catoptric element. The present invention is also applicable to the exposure apparatus of the type having no projection optical system, for example, the proximity type exposure apparatus. The present invention is also applicable to the exposure apparatus which includes an interference optical member to form interference fringes on the substrate wherein the substrate is exposed by forming interference fringes on the substrate. In this case, the liquid immersion area is formed between the interference optical member and the substrate.

The embodiment described above adopts the focus/leveling-detecting system which detects the surface position information about the surface of the substrate P through the liquid LQ. However, it is also allowable to adopt another focus/leveling-detecting system which detects the surface position information about the surface of the substrate P before the exposure or during the exposure without passing through the liquid.

In the specified embodiment described above, the optical element 2, which is disposed at the end portion of the projection optical system PL, is arranged in the opening 70B (light-transmitting section) of the flow passage-forming member 70 with the predetermined spacing distance intervening therebetween. However, any arbitrary optical element may be installed to the opening 70B of the flow passage-forming member 70. That is, the optical element 2 or the optical plate as described above may be held by the flow passage-forming member 70. Also in this arrangement, it is desirable that the projection optical system PL and the flow passage-forming member 70 are supported by separate or distinct support structures in view of the prevention of the transmission of the vibration.

As for the type of the exposure apparatus EX, the present invention is not limited to the exposure apparatus for the semiconductor device production for exposing the substrate P with the semiconductor device pattern. The present invention is also widely applicable, for example, to the exposure apparatus for producing the liquid crystal display device or for producing the display as well as the exposure apparatus for producing, for example, the thin film magnetic head, the image pickup device (CCD), the reticle, or the mask.

When the linear motor is used for the substrate stage PST and/or the mask stage MST, it is allowable to use any one of those of the air floating type based on the use of the air bearing and those of the magnetic floating type based on the use of the Lorentz's force or the reactance force. Each of the stages PST, MST may be either of the type in which the movement is effected along the guide or of the guideless type in which no guide is provided. An example of the use of the linear motor for the stage is disclosed in U.S. Pat. Nos. 5,623,853 and 5,528,118. The contents of the descriptions in these literatures are incorporated herein by reference within a range of permission of the domestic laws and ordinances of the state designated or selected in this international application.

As for the driving mechanism for each of the stages PST, MST, it is also allowable to use a plane motor in which a magnet unit provided with two-dimensionally arranged magnets and an armature unit provided with two-dimensionally arranged coils are opposed to one another, and each of the stages PST, MST is driven by means of the electromagnetic force. In this arrangement, any one of the magnet unit and the armature unit is connected to the stage PST, MST, and the other of the magnet unit and the armature unit is provided on the side of the movable surface of the stage PST, MST.

The reaction force, which is generated in accordance with the movement of the substrate stage PST, may be mechanically released to the floor (ground) by using a frame member so that the reaction force is not transmitted to the projection optical system PL. The method for handling the reaction force is disclosed in detail, for example, in U.S. Pat. No. 5,528,118 (Japanese Patent Application Laid-open No. 8-166475). The contents of the descriptions of these literatures are incorporated herein by reference within a range of permission of the domestic laws and ordinances of the state designated or selected in this international application.

The reaction force, which is generated in accordance with the movement of the mask stage MST, may be mechanically released to the floor (ground) by using a frame member so that the reaction force is not transmitted to the projection optical system PL. The method for handling the reaction force is disclosed in detail, for example, in U.S. Pat. No. 5,874,820 (Japanese Patent Application Laid-open No. 8-330224). The disclosures of these literatures are incorporated herein by reference within a range of permission of the domestic laws and ordinances of the state designated or selected in this international application.

As described above, the exposure apparatus EX according to the embodiment of the present invention is produced by assembling the various subsystems including the respective constitutive elements as defined in claims so that the predetermined mechanical accuracy, the electric accuracy, and the optical accuracy are maintained. In order to secure the various accuracies, those performed before and after the assembling include the adjustment for achieving the optical accuracy for the various optical systems, the adjustment for achieving the mechanical accuracy for the various mechanical systems, and the adjustment for achieving the electric accuracy for the various electric systems. The steps of assembling the various subsystems into the exposure apparatus include, for example, the mechanical connection, the wiring connection of the electric circuits, and the piping connection of the air pressure circuits in correlation with the various subsystems. It goes without saying that the steps of assembling the respective individual subsystems are performed before performing the steps of assembling the various subsystems into the exposure apparatus. When the steps of assembling the various subsystems into the exposure apparatus are completed, the overall adjustment is performed to secure the various accuracies as the entire exposure apparatus. It is desirable that the exposure apparatus is produced in a clean room in which, for example, the temperature and the cleanness are managed.

As shown in FIG. 14, the microdevice such as the semiconductor device is produced by performing, for example, a step 201 of designing the function and the performance of the microdevice, a step 202 of manufacturing a mask (reticle) based on the designing step, a step 203 of producing a substrate as a base material for the device, an exposure process step 204 of exposing the substrate with a pattern of the mask by using the exposure apparatus EX of the embodiment described above, a step of assembling the device (including a dicing step, a bonding step, and a packaging step) 205, and an inspection step 206.

### INDUSTRIAL APPLICABILITY

According to the present invention, the problem inherent in the liquid immersion exposure, which is found out by the present inventors, can be solved. It is possible to accurately perform the exposure process and the control of the position of the mover capable of holding the substrate in the liquid immersion exposure apparatus.

1. An exposure apparatus which exposes a substrate by radiating an exposure light beam onto the substrate through a liquid, the exposure apparatus comprising:
a mover which is capable of holding the substrate;
an interferometer system which radiates a measuring light beam onto a reflecting surface formed on the mover and which receives a reflected light beam therefrom to measure position information about a position of the mover; and
a memory which stores, as first information, error information about an error of the reflecting surface obtained in the presence of the liquid supplied onto the mover.

2. The exposure apparatus according to claim 1, wherein the memory stores, as second information, error information about an error of the reflecting surface obtained in the absence of the liquid supplied onto the mover.

3. The exposure apparatus according to claim 2, further comprising a control unit which controls the position of the mover on the basis of the first information and the position information measured by the interferometer system in the presence of the liquid supplied onto the mover, and which controls the position of the mover on the basis of the second information and the position information measured by the interferometer system in the state in which the liquid is not supplied onto the mover.

4. The exposure apparatus according to claim 3, wherein the first information and the second information include correction information to control movement of the mover by compensating the error of the reflecting surface.

5. The exposure apparatus according to claim 3, wherein the control unit controls the position of the mover on the basis of the first information and the position information measured by the interferometer system when the substrate is exposed, and the control unit controls the position of the mover on the basis of the second information and the position information measured by the interferometer system when a plurality of marks on the substrate are detected.

6. The exposure apparatus according to claim 1, wherein the error of the reflecting surface includes a warpage of the reflecting surface.

7. The exposure apparatus according to claim 1, wherein the error of the reflecting surface includes an inclination of the reflecting surface.

8. The exposure apparatus according to claim 1, wherein the reflecting surface is formed substantially in a first direction, and the first information includes a plurality of pieces of information corresponding to a plurality of positions in a second direction substantially perpendicular to the first direction.

9. The exposure apparatus according to claim 8, wherein the mover has a second reflecting surface which extends in the second direction, and the first information includes error information about an error of the second reflecting surface.

10. The exposure apparatus according to claim 9, wherein the first information includes a plurality of pieces of information corresponding to a plurality of positions in the first direction, as the error information about the error of the second reflecting surface.

11. The exposure apparatus according to claim 1, wherein the mover has a first reflecting surface and a second reflecting surface which is substantially perpendicular to the first reflecting surface, and the first information includes a plurality of pieces of information corresponding to positions of the liquid on the mover, as error information about an error of the first reflecting surface and error information about an error of the second reflecting surface.

12. The exposure apparatus according to claim 1, wherein the mover has a first reflecting surface and a second reflecting surface which is substantially perpendicular to the first reflecting surface, and the first information includes orthogonality error information about an error of orthogonality between the first reflecting surface and the second reflecting surface.

13. An exposure apparatus which exposes a substrate by radiating an exposure light beam onto the substrate through a liquid, the exposure apparatus comprising:
a mover which holds the substrate;
a driving unit which moves the mover; and
a control unit which controls the driving unit and which includes first control information for moving the mover in the presence of the liquid supplied onto the mover, and second control information for moving the mover in the absence of the liquid supplied onto the mover, wherein the control unit controls the driving unit.

14. The exposure apparatus according to claim 13, wherein the first control information corresponds to a position on the mover, of a liquid immersion area formed on the mover.

15. The exposure apparatus according to claim 13, further comprising:
an interferometer system which radiates a measuring light beam onto a reflecting surface formed on the mover and which receives a reflected light beam therefrom to measure position information about a position of the mover, wherein:
the first control information and the second control information include information about an error of the reflecting surface.

16. The exposure apparatus according to claim 13, further comprising a measuring system which performs measurement on the mover, wherein a position of the mover is controlled based on the second control information when the measurement is performed with the measuring system.

17. The exposure apparatus according to claim 1, further comprising a projection optical system, wherein the exposure light beam is radiated onto the substrate via the liquid and the projection optical system.

18. A position control method for controlling a position of a mover by using a reflecting surface formed on the mover which holds a substrate in an exposure apparatus for exposing the substrate by radiating an exposure light beam onto the substrate through a liquid, the position control method comprising:
measuring error information about an error of the reflecting surface in the presence of the liquid supplied onto the mover; and
controlling the position of the mover on the basis of the error information.

19. The position control method according to claim 18, wherein the error of the reflecting surface includes a warpage of the reflecting surface.

20. The position control method according to claim 18, wherein the error of the reflecting surface includes a inclination of the reflecting surface.

21. The position control method according to claim 18, wherein the error information about the error of the reflecting surface is measured in a state in which the substrate is held on the mover.

22. The position control method according to claim 21, wherein a surface of the substrate held on the mover when the error information about the error of the reflecting surface is measured has a contact angle with respect to the liquid, the contact angle being substantially same as a contact angle with respect to the liquid of a surface of the substrate as an exposure objective to be irradiated with the exposure light beam.

23. The position control method according to claim 18, wherein a position of a liquid immersion area on the mover is changed accompanied with movement of the mover, and the error information about the error of the reflecting surface is measured a plurality of times while changing the position of the mover.

24. The position control method according to claim 18, wherein the reflecting surface is formed on the mover substantially in a first direction, and the error information about the error of the reflecting surface is measured while moving the mover to a plurality of positions in a second direction substantially perpendicular to the first direction.

25. The position control method according to claim 24, wherein a plurality of measuring beams, which are substantially in parallel to the first direction, are radiated onto the reflecting surface from an interferometer system which measures position information about the position of the mover during movement of the mover in the second direction, and reflected light beams from the reflecting surface are received to measure the error information about the error of the reflecting surface on the basis of a light-receiving result.

26. The position control method according to claim 18, wherein error information about an error of the reflecting surface is measured in the absence of the liquid supplied onto the mover.

27. The position control method according to claim 26, wherein the error information about the error of the reflecting surface is measured in the absence of the liquid supplied onto the mover, and then the liquid is supplied onto the mover so that the error information about the error of the reflecting surface is measured in the presence of the liquid supplied onto the mover.

28. The position control method according to claim 18, wherein the exposure light beam is radiated onto the substrate via the liquid and a projection optical system in the exposure apparatus.

29. A method for producing a device, comprising using the position control method as defined in claim 18.

30. An exposure apparatus which exposes a substrate by radiating an exposure light beam onto the substrate through a liquid, the exposure apparatus comprising:
an exposure station in which the exposure light beam is radiated onto the substrate through the liquid;
a measuring station which is provided with a measuring system and in which the substrate is measured and exchanged;
a mover which is movable between the exposure station and the measuring station while holding the substrate;
a driving unit which moves the mover; and
a control unit which controls the driving unit and which includes first control information for moving the mover in the presence of the liquid supplied onto the mover, and second control information to move the mover in the absence of the liquid supplied onto the mover, wherein:
an exposure is performed for the substrate through the liquid while controlling movement of the mover on the basis of the first control information when the mover is disposed in the exposure station, and measurement is performed while controlling the movement of the mover on the basis of the second control information when the mover is disposed in the measuring station.

31. The exposure apparatus according to claim 30, wherein the measurement is performed in the absence of the liquid supplied in the measuring station.

32. The exposure apparatus according to claim 30, wherein the mover has a plurality of stages.

33. The exposure apparatus according to claim 32, wherein the plurality of stages include reflecting mirrors respectively, and the first control information and the second control information include error information about an error of each of the reflecting mirrors.

34. An exposure apparatus which exposes a substrate by radiating an exposure light beam onto the substrate through a liquid, the exposure apparatus comprising:
an optical member through which the exposure light beam passes;
a mover which is movable on a light-outgoing side of the optical member;
an interferometer system which radiates a measuring light beam onto a reflecting surface formed on the mover and which receives a reflected light beam therefrom to measure position information about a position of the mover; and
a memory which stores, as first information, error information about an error of the reflecting surface obtained in the presence of a liquid immersion area formed on the mover.

35. The exposure apparatus according to claim 34, wherein the memory stores, as second information, error information about an error of the reflecting surface obtained in the absence of the liquid immersion area formed on the mover.

36. The exposure apparatus according to claim 34, wherein the mover is movable while holding the substrate.

37. The exposure apparatus according to claim 34, wherein:
the reflecting surface is formed substantially in a first direction; and
the mover is moved to a plurality of positions in a second direction perpendicular to the first direction to obtain error information about an error of the reflecting surface at each of the plurality of positions in the second direction.

38. The exposure apparatus according to claim 34, wherein:
the reflecting surface is formed substantially in a first direction; and
the error information about the error of the reflecting surface is measured while moving the mover in the first direction.

39. A method for producing a device, comprising using the exposure apparatus as defined in claim 1.

40. An exposure method for exposing a substrate by projecting an image of a pattern onto the substrate through a liquid, the exposure method comprising:
holding the substrate or a dummy substrate on a mover provided with a reflecting surface onto which a measuring light beam for positional measurement is radiated;
determining error information about an error of the reflecting surface in the presence of the liquid supplied onto the mover; and
projecting the pattern image onto a predetermined position on the substrate through the liquid on the basis of the error information.

41. The exposure method according to claim 40, further comprising detecting a mark formed on the substrate without supplying the liquid onto the substrate to obtain alignment information about the substrate.

42. The exposure method according to claim 41, further comprising determining error information about an error of the reflecting surface without supplying the liquid onto the substrate, wherein the alignment information is obtained while controlling the position of the mover on the basis of the determined error information.

43. The exposure method according to claim 40, further comprising performing a measurement process during which the liquid is being supplied onto the mover, while controlling the position of the mover on the basis of the error information about the error of the reflecting surface.

44. The exposure method according to claim 43, further comprising exchanging the substrate after completion of exposure for the substrate, wherein the error information about the error of the reflecting surface is determined by radiating the measuring light beam onto the reflecting surface when the substrate is exchanged.

45. The exposure method according to claim 44, wherein only in a case a lot of the substrate is changed, the error information about the error of the reflecting surface is determined in exchanging the substrate.

46. The exposure apparatus according to claim 13, further comprising a projection optical system, wherein the exposure light beam is radiated onto the substrate via the liquid and the projection optical system.

47. A method for producing a device, comprising using the exposure apparatus as defined in claim 13.

48. A method for producing a device, comprising using the exposure apparatus as defined in claim 30.

49. A method for producing a device, comprising using the exposure apparatus as defined in claim 34.
